(19) United States
(12) Patent Application Publication
(10) Pub. No.: US 2016/0008906 A1
(43) Pub. Date: Jan. 14, 2016

(54) SOLID WIRE FOR GAS SHIELDED ARC WELDING, WELD METAL BY GAS SHIELDED ARC WELDING, WELDED JOINT, WELDMENT, WELDING METHOD, AND PRODUCTION METHOD OF WELDED JOINT

(71) Applicant: NIPPON STEEL & SUMITOMO METAL CORPORATION, Chiyoda-ku, Tokyo (JP)

(72) Inventors: Tasuku ZENIYA, Tokyo (JP); Shinji KODAMA, Tokyo (JP); Shoko TSUCHIYA, Tokyo (JP); Yasuaki NAITO, Tokyo (JP)

(73) Assignee: NIPPON STEEL & SUMITOMO METAL CORPORATION, Chiyoda-ku, Tokyo (JP)

(21) Appl. No.: 14/766,962

(22) PCT Filed: Feb. 17, 2014
(86) PCT No.: PCT/JP2014/053668

§ 371 Date: Aug. 10, 2015

(30) Foreign Application Priority Data
Feb. 15, 2013 (JP) 2013-027411

(51) Int. Cl. B23K 9/02; B23K 35/30; C22C 38/28; C22C 38/26; C22C 38/24; C22C 38/20; C22C 38/18; C22C 38/16; C22C 38/14; C22C 38/12; C22C 38/06; C22C 38/04; C22C 38/02; C22C 38/00; B23K 35/02

(52) U.S. Cl. CPC B23K 9/02; B23K 35/0261; B23K 35/3086; B23K 35/3073; C22C 38/28; C22C 38/26; C22C 38/24; C22C 38/20; C22C 38/18; C22C 38/16; C22C 38/14; C22C 38/12; C22C 38/06; C22C 38/04; C22C 38/02; C22C 38/002

(57) ABSTRACT

A solid wire for gas shielded arc welding comprising the following in terms of mass-% with respect to a total mass of the wire including plating: C: from 0.03 to 0.15%, Si: from 0.2 to 0.5%, Mn: from 0.3 to 0.8%, P: 0.02% or less, S: 0.02% or less, Al: from 0.1 to 0.3%, Ti: from 0.001 to 0.2%, Cu: from 0 to 0.5%, Cr: from 0 to 2.5%, Nb: from 0 to 1.0%, and V: from 0 to 1.0%, wherein the balance is Fe and impurities, and the following value of X is in a range of from 1.5 to 3.5 mass %. A welding metal, wherein the X value of the following formula is in a range of from 1.0 to 4.0%. Further, a welded joint, a weldment, and a welding method of the welded joint, utilizing the solid wire or the weld metal.

X=2×[Si]+[Mn]+3×[Ti]+5×[Al]

### CROSS-REFERENCE TO RELATED APPLICATION

This application is a national stage application of International Application No. PCT/JP2014/053668, filed Feb. 17, 2014, which is incorporated by reference herein in its entirety, and which claims priority to Japanese Application No. 2013-02741,1 filed on Feb. 15, 2013.

### TECHNICAL FIELD

The present invention relates to a solid wire for welding a steel sheet, such as a zinc-coated steel sheet to be used as a structural member for an automobile suspension system, by a gas shielded arc welding method. Further, the invention relates to a weld metal, a welded joint, and a weldment, welded by a gas shielded arc welding method. Further, the invention relates to a welding method, and a welded joint by a gas shielded arc welding method.

### BACKGROUND ART

As well known a zinc-coated steel sheet or a zinc alloy-coated steel sheet is often used as a steel sheet for a structural member of an automobile suspension system, which is coated after welding. Further, gas shielded arc welding represented by carbon dioxide gas shielded arc welding is often applied to welding of a structural member of an automobile suspension system.

In this regard, when a steel sheet is arc-welded, a blowhole may be generated in a welded joint, namely in a weld metal. Especially, it has been known that a blowhole is apt to be generated, when a zinc-coated steel sheet or a zinc alloy-coated steel sheet (hereinafter a zinc-coated steel sheet and a zinc alloy-coated steel sheet are collectively referred to as a “zinc- or zinc alloy-coated steel sheet”) is arc-welded.

A blowhole is a void remained as the result of inclusion of a bubble in a weld metal during solidification of the weld metal, wherein the bubble is generated by a reaction of carbon and oxygen in the weld metal to a CO₂ gas, gasification of various adsorbed components, or gasification by a reaction of a low temperature gasification reaction component. Especially, in the case of a zinc- or zinc alloy-coated steel sheet, low melting point zinc- or zinc alloy plated on a steel sheet surface evaporates during welding, and the zinc vapor forms a bubble in a weld metal in a molten state, and therefore a blowhole is apt to be generated. When a large number of blowholes are generated, the strength of a welded joint decreases to invite difficulty in using the same as a structural member, and possibility of a coating defect, or poor appearance or shape of a weld bead increases.

Meanwhile, a steel sheet used as a structural member for an automobile suspension system is generally painted by electrodeposition coating after welding. However, when welding is performed by a gas shielded arc welding method, since CO₂ or Ar+20% CO₂ is used as a shielding gas, a deoxidizing element, such as Si and Mn in a weld wire reacts with an oxygen component in a shielding gas to form an oxide in a welding process. The oxide floats up to a surface of a molten weld metal as slag. Since the slag (oxide) is not electrically conductive, electrodeposition coating on the slag on a surface of a weld bead is not possible, which may cause coating failure, or coating defect leading to deterioration of the corrosion resistance or fine appearance of the welded part after painting.

Therefore, when a steel sheet, especially a zinc- or zinc alloy-coated steel sheet used as a structural member for an automobile suspension system is subjected to gas shielded arc welding, blowholes in a weld metal at a welded joint should be suppressed as far as possible. At the same time, it is required to suppress as far as possible generation of slag on a weld metal surface.

Meanwhile, as a weld wire to be used for gas shielded arc welding of a zinc- or zinc alloy-coated steel sheet, a weld wire, with which generation of a blowhole and a pit arising therefrom mainly in gas shielded arc welding are suppressed, has been proposed in Patent Literature 1.

The weld wire proposed in Patent Literature 1 contains, in weight-%, C: from 0.03 to 0.15%, Si: from 1.00 to 2.50%, and Mn: from 0.10 to 1.00% provided that Mn/Si is in a range not higher than 0.65%, P: 0.013% or less, a total of one or two of Al and Ti is from 0.005 to 0.200%, a total of one or two of S and O is from 0.0050 to 0.0500%, and the balance is Fe and incidental impurities.

It is alleged in Patent Literature 1 that generation of a pit and a blowhole can be suppressed by regulating Si, Mn, Al, and Ti, which are deoxidizing elements, contained in a weld wire as above, and especially by adding Si as much as from 1.00 to 2.50%.

Further, in Patent Literature 2, with respect to a lap fillet are welding method and a lap fillet arc welding joint of a zinc- or zinc alloy-coated steel sheet, a technology for improving a pore defect from a pit or a blowhole, a welding failure, such as spatter, and undercut, and gap resistance has been proposed.

Patent Literature 2 discloses, with respect to a lap fillet arc welding method of a zinc- or zinc alloy-coated steel sheet, a regulation that the Si content in a weld metal is regulated to 0.5% or less, and a total content of Si and Al in a steel sheet, which is a base metal of an upper sheet out of upper and lower two zinc- or zinc alloy-coated steel sheets to be welded by lap fillet arc welding, is regulated to 0.35% or more, as well as a thus regulated welded joint. Namely, it is alleged that generation of a blowhole can be suppressed by regulating the Si content in a weld metal at 0.5% or less, and that the gap resistance (welding stability with respect to gap length) can be maintained by regulating the total content of Si and Al in a base metal steel sheet, which is a material to be welded, at 0.35% or more.

In Patent Literature 3, an invention for improving slag releasability is disclosed. Precisely, it is disclosed that slag generated be welding is mainly composed of a metallic oxide of a SiO₂—FeO—MnO system, and the properties of slag are determined by the relative content of Si and Mn in a weld metal, so that the Si content in a weld metal should be high and the Mn content should be low. Further, it has been discovered that by the above means, generated slag becomes thin and fine, and the releasability becomes favorable (Patent Literature 3, page 3 upper left column, upper right column and FIG. 1). Accordingly, a solid wire for gas shielded arc welding containing a high Si content and a low Mn content, as well as a method for performing lap fillet welding using the same are disclosed.

In Patent Literature 4, an invention for reducing generation of slag is disclosed. Precisely, a method, by which the deoxidizing effect is regulated by adding appropriately Si, Mn, Al, etc. having high deoxidizing power, so as to suppress a pit or a blowhole, is disclosed (Patent Literature 4. [0012], [0013]). Further, at the same time, a wire for gas shielded arc welding, with which the covering area by slag stuck to a bead surface can be reduced by regulating the amounts of S and O in an optimal range, is disclosed (Patent Literature 4, [0015]).

In Patent Literature 5 an invention for reducing generating slag is disclosed. Precisely, it is disclosed that for high heat input high interpass temperature gas shielded arc welding with respect to CO₂ arc welding, B, and Mo are added together with C, Si, Mn, Al, Ti, and Cu regulated in specific ranges. A weld wire for gas shielded arc welding, which can prevent decrease in the strength of a weld metal and decrease in toughness, and at the same time is characterized by low generation of slag and stable welding operability, is disclosed (Patent Literature 5. [0012]).

In Patent Literature 6 an invention for reducing generation of slag is disclosed. Precisely, an example of a weld wire for gas shielded arc welding, which prevents decrease in the mechanical property of a weld, results in low generation of slag, and has favorable releasability of slag, in high heat input high interpass temperature gas shielded arc welding with respect to CO₂ arc welding, is disclosed. This invention is a solid wire for gas shielded arc welding, with which the generation amount of slag can be reduced by setting upper limits of the contents of Mn, Ti and O in the wire, and the releasability of slag can be improved by having S included and by setting upper limits of the contents of Mn, Mo and Cu (Patent Literature 6, [0010]).

Further, in Patent Literature 7, in order to stabilize an arc throughout welding and to improve welding operability by smoothing droplet transfer conditions, a weld wire, in which the composition is defined properly and a part of the composition is concentrated at a wire surface, is proposed.

In Patent Literature 8, a weld wire, which suppresses generation of a pit, and a blowhole by mitigating an influence of zinc and nitrogen by a combined effect of: 1) promotion of oxidation of zinc by decreasing the contents of C, Si, Ti, and Al, having high deoxidizing power at a high temperature, to activate an oxidation reaction; 2) facilitation of gas release from a molten pool by attaining viscosity decrease of a molten pool by raising oxygen potential through the activation of an oxidation reaction, and 3) fixation of nitrogen in the pool by adding Ti, Al, and Nb having high affinity for nitrogen, is proposed.

In Patent Literature 9, a welding method, by which a predetermined steel sheet and a weld wire are combined in order to form a favorable weld toe shape and to improve a fatigue characteristic of a welded joint even at a welding speed beyond 80 cm/min, is proposed.

Patent Literature 1: Japanese Patent Application Laid-Open (JP-A) No. H7-80478

### Patent Literature 2: JP-A No. 2012-101232

Patent Literature 3: JP-A No. S62-124095
Patent Literature 4: JP-A No. H7-80678

### Patent Literature 5: JP-A No. 2004-237361

### Patent Literature 6: JP-A No. 2006-26643

Patent Literature 7: JP-A No. H1-150494
Patent Literature 8: JP-A No. H3-204195

### Patent Literature 9: JP-A No. 2009-226476

### SUMMARY OF INVENTION

### Technical Problem

It is so understood that the technology in Patent Literature 1 intends mainly to suppress generation of a pit, which is formed when a blowhole appears at a surface of a weld metal after solidification, rather than to suppress generation itself of a blowhole. In other words, in Patent Literature 1, a target is a weld wire for gas shielded arc welding of a zinc- or zinc alloy-coated steel sheet with a thick zinc plating layer (namely, heavy coating weight sheet) considering a use as a building material, etc. For example, in an Example of Patent Literature 1, a target is a heavy coating weight zinc-coated steel sheet, with a zinc coating weight per single side of 270 g/m², which is hot-dip galvanized on both sides. In a case of such a heavy coating weight, it is difficult to prevent completely generation itself of a blowhole. Therefore, the technology of Patent Literature 1 is based on a concept that residual blowholes in a weld metal up to a certain level are allowed, while the blowholes should be confined inside a weld metal so as to prevent them from coming out to a weld metal surface and forming pits. Namely, the strategy is so understood that formation of a pit at a weld metal surface should be prevented based on the above concept through confinement of blowholes inside the weld metal by increasing to some extent the viscosity of the weld metal in a molten state by adding a relatively large amount of Si into a welding wire.

However, the thickness of a zinc plating layer of a zinc-coated steel sheet to be used as an automobile structural member is ordinarily thinner than that of a building material application, and the sheet is mostly coated relatively lightly at a zinc coating weight in a range of approx. from 30 to 120 g/m² per single side. When a zinc-coated steel sheet with such a light coating weight is welded by a gas shielded arc welding method, it is difficult to confine a blowhole inside a weld metal, even if the viscosity of a molten state weld metal is increased. Rather, the viscosity increase may make it difficult for a blowhole to escape from a weld metal, leading to increase in blowholes. Further, there is a drawback that, when the amount of Si is increased in order to increase the viscosity, the amount of slag may increase also. Therefore, according to the technology in Patent Literature 1, practically it was difficult to suppress surely and stably generation of a blowhole, and at the same time to suppress generation of slag, when a zinc-coated steel sheet with a relatively light coating weight is welded by gas shielded arc welding.

In Patent Literature 2, with respect to components of a weld wire to be used for arc welding, nothing is described other than Si and Al even in Examples, and with respect to components of a weld metal, nothing is described other than Si.

Since it has been know that the content of an element other than Si and Al has influence on generation of a blowhole, it is not sure whether a blowhole can be suppressed with certainty by application of the technology according to Patent Literature 2 as it is. Further, generation of slag and suppression thereof are not considered sufficiently in a proposal of Patent Literature 2, and therefore it is not certain whether or not generation of slag can be suppressed by application of the technology according to Patent Literature 2.

Further, by technologies disclosed in Patent Literature 3 to 6, as well as Patent Literature 7 and 8, reduction in generation of slag is still not sufficient, and due to a coating failure appeared as a consequence, the corrosion resistance and fine appearance of a weld are not adequately obtainable.

According to the state of the art, there is no established technology, by which generation of a blowhole and generation of a large amount of slag at a weld metal can be suppressed at the same time surely and stably in welding a steel sheet such as a zinc- or zinc alloy-coated steel sheet by gas shielded arc welding.

Although Patent Literature 9 discloses a technology for giving a favorable weld toe shape, and improving a fatigue characteristic of a welded joint, but does not disclose a technology for suppressing generation of a blowhole and slag.

The present invention was made under such circumstances with an object to provide a welding solid wire, which can suppress surely and stably both of generation of a blowhole in a weld metal and generation of slag on a surface of a weld metal after solidification, when a steel sheet such as a zinc- or zinc alloy-coated steel sheet is welded by gas shielded arc welding.

Another object in the invention is to provide a weld metal with limited blowhole and slag as a weld metal having welded, by gas shielded arc welding, zinc- or zinc alloy-coated steel sheets by gas shielded arc welding.

Still another object in the invention is to provide a welded joint, and a weldment with limited blowhole and slag as a welded joint of zinc- or zinc alloy-coated steel sheets welded by gas shielded arc welding.

Still another object in the invention is to provide a welding method, and a production method of a welded joint, by which the amount of blowholes and slag can be decreased in welding zinc- or zinc alloy-coated steel sheets by gas shielded arc welding.

### Solution to Problem

For attaining the objects, the inventors have made various experiments and investigations to find finally that a parameter X defined by the following relationship among the contents by mass % of [Si], [Mn], [Ti], and [Al], with respect to a total mass of the wire including plating, of deoxidizing elements of Si, Mn, Ti, and Al among the components of a welding solid wire to be used for gas shielded arc welding:

X=2×[Si]+[Mn]+3×[Ti]+5×[Al]

has a major effect on generation tendency of a blowhole. Specifically, not only an individual content of each element contained in a welding solid wire is regulated, but also each content is regulated so that the X value falls within the specific range of from 1.5 to 3.5%. It was found that by this means generation of a blowhole can be suppressed with certainty and at the same time generation of slag can be suppressed, thereby completing the invention concerning a solid wire for gas shielded arc welding.

Further, with respect to a weld metal yielded by welding a zinc- or zinc alloy-coated steel sheet by gas shielded arc welding, not only is an individual content of each component element in a weld metal regulated, but also each content is regulated using an X value similar to the above, so that the X value falls within the specific range of from 1.0 to 4.0%. It was found that by this means a welded joint in which the number of blowholes is limited, and the generation amount of slag is also limited, can be obtained, thereby completing the invention concerning a weld metal.

Specifically, a solid wire for gas shielded arc welding according to a basic Embodiment (1st Embodiment) in the invention includes the following in terms of mass % with respect to a total mass of the wire including plating:

C: from 0.03 to 0.15%,
Si: from 0.2 to 0.5%,
Mn: from 0.3 to 0.8%,
P: 0.02% or less,
S: 0.02% or less,
Al: from 0.1 to 0.3%,
Ti: from 0.001 to 0.2%
Cu: from 0 to 0.5%,
Cr: from 0 to 2.5%,
Nb: from 0 to 1.0%, and
V: from 0 to 1.0%
wherein the balance is Fe and impurities, and a value of X defined by the following formula (1) is in a range of from 1.5 to 3.5 mass %:

X=2×[Si]+[Mn]+3×[Ti]+5×[Al] (1)

wherein [Si], [Mn], [Ti], and [Al] each represent a content (mass %) of the respective elements.

With respect to a solid wire for gas shielded arc welding according to the 1st Embodiment, the contents of the respective components with respect to the total amount including plating are regulated such that the X value defined by Formula (1) falls within a range of from 1.5 to 3.5 mass %. By this means, when a steel sheet such as a zinc- or zinc alloy-coated steel sheet is welded by gas shielded arc welding using the wire, generation of a blowhole can be suppressed with certainty. In other words, in a case in which the X value is within the range of from 1.5 to 3.5%, the number of blowholes in a weld metal is remarkably decreased compared to a case in which the X value is less than 1.5%, or beyond 3.5%. This is a novel knowledge, which the inventors have acquired after repeating a large number of experiments and investigations as described below referring to Experiment 1. Further, in this case the Si content in the welding solid wire is restricted to a relatively low level in a range of from 0.2 to 0.5%, and therefore the viscosity of a molten metal during welding will not become excessively high. Therefore, a blowhole can easily float up in the molten metal and released from a molten metal surface outward, which contributes also to reduction of the number of blowholes remaining in the weld metal.

By the above-mentioned technology in Patent Literature 1, the Si content is made relatively high, so that the viscosity of a molten metal during welding becomes relatively high in order to confine a blowhole inside than the surface of a weld metal. On the other hand, with respect to a welding solid wire in the invention, the Si content is in reverse limited to a low level, so as to lower the viscosity of a molten metal for accelerating release of blowholes and as the result the number of blowholes remaining in the molten metal is suppressed low. Therefore, for example, even when a zinc- or zinc alloy-coated steel sheet with a relatively light plating weight (namely, thin plating layer) is used as a base metal (welded material) for gas shielded arc welding, the number of blowholes in a molten metal can be reduced.

In this regard, there is no particular restriction on the type or composition of a subject steel sheet (base metal steel sheet, steel sheet as welded material) of gas shielded arc welding using a welding solid wire according to the 1st Embodiment. For example, when a zinc- or zinc alloy-coated steel sheet is welded by gas shielded arc welding, the effect of a welding solid wire according to the 1st Embodiment becomes remarkable. Precisely, when a zinc- or zinc alloy-coated steel sheet is used as a base metal steel sheet, blowholes are apt to be generated significantly due to zinc in a plating layer, however even in such a case, in which a zinc- or zinc alloy-coated steel sheet is welded by gas shielded arc welding, the number of blowholes can be reduced with certainty by using a solid wire for gas shielded arc welding according to the 1st Embodiment.

Further, with respect to a solid wire for gas shielded arc welding according to the 1st Embodiment, the generation amount of slag during welding can be also suppressed by regulating the X value as above, while the contents of Si, Al, and Ti, which are especially causative sources of slag among various components contained in the wire, are controlled appropriately. Furthermore, by regulating the contents of the respective components in the welding solid wire within the above ranges, a joint with a bead having favorable appearance and shape can be obtained with limited generation of spatter in performing gas shielded arc welding using the welding solid wire.

a solid wire for gas shielded arc welding according to the 2nd Embodiment in the invention includes one, or two or more kinds of the following in terms of mass % with respect to the total mass of the wire including plating in the solid wire for gas shielded arc welding according to the 1st Embodiment:

Cu: from 0.05 to 0.5%,
Cr: from 0.005 to 2.5%,
Nb: from 0.005 to 1.0%, or
V: from 0.005 to 1.0%.

With respect to such a solid wire for gas shielded arc welding according to the 2nd Embodiment, the solid wire may contain, as a component of a weld metal, Cu originated from copper plating provided on a wire surface. Further, by containing one, or two or more kinds among Cr, Nb, or V at an appropriate amount, the strength of a weld metal can be improved without impairing the inhibitory effect on a blowhole or the inhibitory effect on slag.

A weld metal welded by gas shielded arc welding is prescribed according to the 3rd Embodiment and the 4th Embodiment.

Namely, a weld metal by gas shielded arc welding according to the 3rd Embodiment includes the following in terms of mass % with respect to a total mass of the weld metal:

C: from 0.03 to 0.15%,
Si: from 0.1 to 0.5%,
Mn: from 0.3 to 1.2%,
P: 0.02% or less,
S: 0.02% or less,
Al: from 0.05 to 0.3%,
Ti: from 0.001 to 0.2%
wherein the balance is Fe and impurities, and a value of X defined by the following formula (2) is in a range of from 1.0 to 4.0 mass %:

X=2×[Si]+[Mn]+3×[Ti]+5×[Al] (2)

wherein [Si], [Mn], [Ti], and [Al] each represent a content (mass %) of the respective elements.

With respect to such a weld metal according to the 3rd Embodiment, the contents of the respective components of the weld metal are regulated such that the X value defined by Formula (2) falls within a range of from 1.0 to 4.0%. By this means, with respect to a weld metal of gas shielded arc welding using a zinc- or zinc alloy-coated steel sheet, with which a blowhole is apt to be generated, as a base metal steel sheet (steel sheet as welded material), blowholes can be limited to a very low level. In other words, in a case in which the X value is within the range of from 1.0 to 4.0% the number of blowholes in a weld metal is remarkably decreased compared to a case in which the X value is less than 1.0%, or beyond 4.0%. This is a novel knowledge, which the inventors have acquired after repeating a large number of experiments and investigations as described below referring to Experiment 3. Further, in this case the Si content in the weld metal is restricted to a relatively low level in a range of from 0.1 to 0.5%, and the viscosity of a molten metal during welding will not become excessively high. Therefore, a blowhole can easily float up in the molten metal and released from a molten metal surface outward, which contributes also to reduction of the number of blowholes.

Further, with respect to a weld metal according to the 3rd Embodiment, the generation amount of slag can be also suppressed by regulating the X value as above, while the contents of Si, Al, and Ti, which are especially causative sources of slag generation are controlled appropriately. Furthermore, by regulating the contents of the respective components in the weld metal within the above ranges, a weld metal with a bead having favorable appearance and shape can be obtained with limited generation of spatter.

A weld metal according to the 4th Embodiment in the invention includes one, or two or more kinds of the following in terms of mass % with respect to the total mass of the weld metal in the weld metal according to the 3rd Embodiment:

Cu: from 0 to 0.3%,
Cr: from 0 to 1.5%,
Nb: from 0 to 0.7%, or
V: from 0 to 0.7%,

With respect to such a weld metal according to the 4th Embodiment, a weld metal may contain, as a component of the weld metal, Cu originated from copper plating provided on a wire surface. Further, by containing as a component of the weld metal one, or two or more kinds among Cr, Nb, or V at an appropriate amount, the strength of a weld metal can be improved without impairing the inhibitory effect on a blowhole or the inhibitory effect on slag.

A welded joint welded by gas shielded arc welding is prescribed according to the 5th Embodiment and the 6th Embodiment.

Precisely, a welded joint according to the 5th Embodiment in the invention includes a weld metal formed by gas shielded arc welding at a joint, and two base metals, which sandwich the weld metal, and at least one of which is a zinc- or zinc alloy-coated steel sheet (zinc-coated steel sheet or zinc alloy-coated steel sheet), wherein the weld metal is the weld metal by gas shielded arc welding according to the 3rd Embodiment or the 4th Embodiment.

A welded joint according to the 6th Embodiment in the invention is a welded joint according to the 5th Embodiment, in which a zinc- or zinc alloy-coated steel sheet (zinc-coated steel sheet or zinc alloy-coated steel sheet) contains Al from 0.01 to 0.3 mass % with respect to a total mass of the steel sheet.

With respect to such a welded joint according to the 6th Embodiment, when a weld wire according to the 1st Embodiment or the 2nd Embodiment is used and a zinc- or zinc alloy-coated steel sheet contains Al from 0.01 to 0.3 mass % with respect to the total mass of the steel sheet, the X value specified in Formula (2) can be easily regulated within the range of from 1.0 to 4.0%, and the content of Al within the range of from 0.05 to 0.3%, so that the blowhole generation amount and the slag generation amount can be suppressed easier.

A weldment by gas shielded arc welding is prescribed in the 7th Embodiment. Precisely, a weldment according to the 7th Embodiment in the invention is a weldment including the welded joint according to the 5th Embodiment or the 6th Embodiment.

According to the 8th Embodiment and the 9th Embodiment, a welding method, and a production method of a welded joint by gas shielded arc welding are provided.

Precisely, a welding method according to the 8th Embodiment in the invention is for welding two base metals, at least one of which is a zinc- or zinc alloy-coated steel sheet (zinc-coated steel sheet or zinc alloy-coated steel sheet), by forming a weld metal at a joint by gas shielded arc welding using the solid wire for gas shielded arc welding according to the 1st Embodiment or the 2nd Embodiment.

A production method of a welded joint according to the 9th Embodiment in the invention is a production method of a welded joint including a weld metal at a joint and two base metals, which sandwich the weld metal, and at least one of which is a zinc- or zinc alloy-coated steel sheet (zinc-coated steel sheet or zinc alloy-coated steel sheet), wherein the weld metal is formed by gas shielded arc welding using the solid wire for gas shielded arc welding according to the 1st Embodiment or the 2nd Embodiment.

### Advantageous Effects of Invention

With respect to a solid wire for gas shielded arc welding in the invention, when a steel sheet such as a zinc- or zinc alloy-coated steel sheet is welded by gas shielded arc welding using the wire, both of generation of a blowhole in a weld metal and generation of slag on a weld metal surface after solidification can be surely and stably suppressed. Further, generation of spatter during welding can be reduced, and also a welded joint with a weld bead having favorable shape and appearance can be obtained.

A weld metal by gas shielded arc welding in the invention generates less amounts of blowholes and slag, as a weld metal having welded, by gas shielded arc welding, a zinc- or zinc alloy-coated steel sheet by gas shielded arc welding. Further, a weld metal where a generation of spatter during welding becomes less, and the shape and appearance of a weld bead become favorable, namely a high quality weld metal avoiding most of various welding defects can be obtained, which is, for example, optimal for a structural member of an automobile suspension system.

Further, a welded joint and a weldment in the invention are a welded joint and a weldment by gas shielded arc welding using a base metal (welded material) of a zinc- or zinc alloy-coated steel sheet, and include less blowhole and slag. Further, a welded joint and a weldment, where generation of spatter during welding is insignificant, and the shape and appearance of a weld bead are favorable, are formed. Namely a high quality welded joint and weldment only low in various welding defects can be obtained, which is, for example, optimal for a structural member of an automobile suspension system.

Further, by a welding method, and a production method of a welded joint in the invention, when gas shielded arc welding is conducted using a zinc- or zinc alloy-coated steel sheet as a base metal (welded material), generation of blowholes and slag is reduced. Further, generation of spatter during welding becomes insignificant, and the shape and appearance of a weld bead become favorable. Namely, a high quality welding method and a high quality production method of a welded joint that are low in various welding defects can be obtained, which are, for example, optimal for a structural member of an automobile suspension system.

### BRIEF DESCRIPTION OF DRAWINGS

FIG. 1 is a graph showing results of Experiment 1 concerning a relationship between a value of a parameter X to be determined by the contents of Si, Mn, Ti, and Al in a solid wire for gas shielded arc welding (X=2×[Si]+[Mn]+3×[Ti]+5×[Al]), and the area ratio of blowholes when a zinc-coated steel sheet is welded by gas shielded arc welding using the welding solid wire.

FIG. 2 is a graph showing results of Experiment 2 concerning a relationship between an Al content in a solid wire for gas shielded arc welding, and the area ratio of slag on a bead surface after a zinc-coated steel sheet is welded by gas shielded arc welding.

FIG. 3 is a graph showing results of Experiment 3 concerning a relationship between a value of a parameter X to be determined by the contents of Si, Mn, Ti, and Al in a weld metal (X=2×[Si]+[Mn]+3+[Ti]+5×[Al]), and the area ratio of blowholes in the weld metal, with respect to the weld metal obtained by welding a zinc-coated steel sheet by gas shielded arc welding.

FIG. 4 is a graph showing results of Experiment 4 concerning a relationship between an Al content in a weld metal, and the area ratio of slag on a weld metal surface with respect to the weld metal obtained by welding a zinc-coated steel sheet by gas shielded arc welding.

FIG. 5 is a schematic diagram showing a weld bead surface when bead on plate welding is conducted using a conventional solid wire for gas shielded arc welding.

FIG. 6 is a schematic diagram showing a weld bead surface when bead on plate welding is conducted using a solid wire for gas shielded arc welding in the invention.

### DESCRIPTION OF EMBODIMENTS

Embodiments in the invention will be described below in detail.

Firstly, a solid wire for gas shielded arc welding provided according to the 1st Embodiment, or the 2nd Embodiment will be described.

A basic embodiment (1st Embodiment) of a solid wire for gas shielded arc welding in the invention includes the following in terms of mass % with respect to the total mass of the wire including plating: C: from 0.03 to 0.15%, Si: from 0.2 to 0.5%, Mn: from 0.3 to 0.8%, P: 0.02% or less, S: 0.02% or less, Al: from 0.1 to 0.3%, Ti: from 0.001 to 0.2%, Cu: from 0 to 0.5%, Cr: from 0 to 2.5%, Nb: from 0 to 1.0%, and V: from 0 to 1.0%; wherein the balance is Fe and impurities, and X expressed by the following formula (1) is in a range of from 1.5 to 3.5 mass %:

X=2×[Si]+[Mn]+3×[Ti]+5×[Al] (1)

wherein [Si], [Mn], [Ti], and [Al] each represent the content (mass %) of the respective elements.

Further, another embodiment (2nd Embodiment) of a solid wire for gas shielded arc welding in the invention includes the above elements in terms of mass % with respect to the total mass of the wire including plating, namely: C: from 0.03 to 0.15%, Si: from 0.2 to 0.5%, Mn: from 0.3 to 0.8%, P: 0.02% or less, S: 0.02% or less. Al: from 0.1 to 0.3%, and Ti: from 0.001 to 0.2%, and further one, or two or more kinds out of Cu: from 0.05 to 0.5%, Cr: from 0.005 to 2.5%, Nb: from 0.005 to 1.0%, or V: from 0.005 to 1.0%; wherein the balance is Fe and impurities, and the value of X defined by Formula (1) similarly as above is in a range of from 1.5 to 3.5 mass %.

In this regard, in any of the above Embodiments, Si, Mn, Al, and Ti among the respective component elements are preferably within ranges of Si: from 0.3 to 0.5%, Mn: from 0.4 to 0.8%, Al: from 0.15 to 0.3%, and Ti: from 0.05 to 0.2%, respectively.

The reasons behind the restrictions on the composition of a solid wire for gas shielded arc welding will be described below.

[C: 0.03 to 0.15%]

Since C has an effect of stabilizing an arc and reducing the particle size of a droplet, when the C content is less than 0.03%, a droplet becomes too coarse, an arc becomes unstable, and the generation amount of spatter increases. On the other hand, when the C content exceeds 0.15%, the viscosity of a molten metal decreases to deteriorate the bead shape and also to harden a weld metal leading to poor crack resistance. Therefore, the C content in a welding solid wire is set in a range of from 0.03 to 0.15%.

[Si: 0.2 to 0.5%, Preferably 0.3 to 0.5%]

Si is an element promoting deoxidation of a molten metal during arc welding (deoxidizing element), and has an effect of suppressing generation of a blowhole, on the other hand, however, when Si is contained excessively, this element increases generation of slag significantly. When the Si content is less than 0.2%, deoxidation becomes insufficient, and a blowhole is apt to be generated, and when the Si content exceeds 0.5%, slag increases conspicuously. Consequently, for the balance between suppression of blowhole generation and slag amount suppression, the Si content in a welding solid wire is set in a range of from 0.2 to 0.5%. Furthermore, even within this range, particularly if the Si content is set within a range of from 0.3 to 0.5%, it is possible to achieve both reduction of blowholes and slag amount suppression more effectively.

[Mn: 0.3 to 0.8%, Preferably 0.4 to 0.8%]

Mn is also a deoxidizing element, and has an effect of promoting deoxidation of a molten metal during arc welding and suppressing generation of a blowhole, on the other hand, however, Mn is an element which increases the viscosity of a molten metal. When the Mn content is less than 0.3%, deoxidation becomes insufficient, and a blowhole is apt to be generated. On the other hand, when the Mn content exceeds 0.8%, the viscosity of a molten metal increases, and if the welding speed is high, a molten metal is not able to flow into a weld site appropriately to form a humping bead and a defective bead shape is apt to appear. Consequently, the Mn content in a welding solid wire is set in a range of from 0.3 to 0.8%. For suppressing generation of a blowhole with certainty, the Mn content is more preferably within a range of from 0.4 to 0.8%.

[Al: 0.1 to 0.3%, Preferably 0.15 to 0.3%]

Al is a strongly deoxidizing element and has a strong effect of promoting deoxidation of a molten metal during are welding, on the other hand, however, it is also an element that promotes generation of slag remarkably. When the Al content in a welding solid wire is less than 0.1%, deoxidation becomes insufficient, and a blowhole is apt to be generated. On the other hand, when the Al content exceeds 0.3%, slag increases conspicuously. Consequently, for the balance between suppression of blowhole generation and slag amount suppression, the Al content in a welding solid wire is set in a range of from 0.1 to 0.3%. Furthermore, even within this range, particularly if the Al content is set within a range of from 0.15 to 0.3%, it is possible to achieve both suppression of blowhole generation and slag amount suppression more effectively.

[Ti: 0.001 to 0.2%, Preferably 0.05 to 0.2%]

Inclusion of Ti is effective for improving arc stability in a high current zone. Further, Ti is a deoxidizing element and has an effect of suppressing generation of a blowhole. When the Ti content is less than 0.001%, these effects cannot be manifested fully. On the other hand, when the Ti content exceeds 0.2%, a slag generation reaction is promoted to increase the slag amount. Consequently, the Ti content in a welding solid wire is set in a range of from 0.001 to 0.2%. Furthermore, even within this range, particularly if the Ti content is set within a range of from 0.05 to 0.2%, the aforedescribed effect can be manifested fully, without invoking increase in the slag amount.

[P: Less than 0.02%]

P is an element, which generally comes to be mixed in a steel as one of incidental impurities, and is usually contained as an impurity in a solid wire for arc welding. Meanwhile, P is one of the major elements, which cause hot crack of a weld metal, and should be preferably suppressed as much as possible, because when the P content exceeds 0.02%, hot crack of a weld metal becomes significant. Therefore, the P content in a welding solid wire is limited to 0.02% or less. Although there is no particular restriction on the lower limit of the P content, it is preferably 0.001% from a viewpoint of the cost of dephosphorization and productivity.

[S: Less than 0.02%]

S is also an element, which generally comes to be mixed in a steel as one of incidental impurities, and is usually contained as an impurity in a solid wire for arc welding. Meanwhile, S is an element, which retards the crack resistance of a weld metal, and should be preferably suppressed as much as possible, because when the S content exceeds 0.02%, the crack resistance of the weld metal is deteriorated. Therefore, the S content in a welding solid wire is limited to 0.02% or less. Although there is no particular restriction on the lower limit of the S content, it is preferably 0.001% from a viewpoint of the cost of desulfurization and productivity.

[One, or Two or More Kinds of Cu: 0 to 0.5%, Cr: 0 to 2.5%, Nb: 0 to 1.0%, V: 0 to 1.0%]

Cu is an element originated from copper plated on a wire surface as needed. Cr, Nb, and V are elements for improving the strength of a weld metal. In the invention, if necessary a welding solid wire contains elements of Cu, Cr, Nb, or V. It may contain only 1 kind of Cu, Cr, Nb, or V, or may contain 2 or 3 kinds thereof at the same time.

The Cu content is set in a range of from 0 to 0.5%. Although Cu is an element that is occasionally contained in a steel generally at approx. 0.02% as an impurity, in the case of a solid wire for arc welding in the invention. Cu is mainly originated from copper plating on a wire surface. In other words, with respect to a solid wire for arc welding, copper plating is a very important surface treatment method for stabilizing the wire feedability and the current conduction, and some amount of Cu is inevitably included therein in a case in which copper plating is carried out. When the Cu content is less than 0.05%, required wire feedability and current conduction cannot be achieved, and on the other hand, when the Cu content exceeds 0.5%, the sensitivity to weld crack grows worse. Therefore, the Cu content in the total wire including the plating is preferably set in a range of from 0.05 to 0.5%.

The Cr content is set in a range of from 0 to 2.5%. When Cr is contained, the Cr content is preferably set in a range of from 0.005% to 2.5%. This is because at the Cr content of 0.005% or more, a strength improvement effect on a weld metal manifests itself however, when the Cr content exceeds 2.5%, the toughness of a weld metal is impaired. The Cr content is preferably 0.3% or more, and more preferably 0.8% or more, from a viewpoint of strength improvement effect.

The Nb content is set in a range of from 0 to 1.0%. When Nb is contained, the Nb content is preferably set in a range of from 0.005% to 1.0%. This is because at the Nb content of 0.005% or more, a strength improvement effect on a weld metal manifests itself, however, when the Nb content exceeds 1.0%, the toughness of a weld metal is impaired.

The V content is set in a range of from 0 to 1.0%. When V is contained, the V content is preferably set in a range of from 0.005% to 1.0%. This is because at the V content of 0.005% or more, a strength improvement effect on a weld metal manifests itself, however, when the content exceeds 1.0%, the toughness of a weld metal is impaired.

[Impurities]

Impurities means an ingredient contained in a source material, or an ingredient having been mixed in a production process, which is not intentionally added in a solid wire.

Further, for a solid wire for gas shielded arc welding in the invention, it is important that not only are the individual contents of respective component elements regulated, but also that the relationship among the contents of Si, Mn, Ti, and Al is adjusted, so that, under the mutual relationship of the contents, the X value according to Formula (1) falls within a range of from 1.5 to 3.5%.

Precisely, the inventors have found that even when the individual contents of elements contained in a wire are within the above ranges, blowholes can generate in some cases remarkably. As the result of additional detailed experiments, and investigations, the inventors have finally found that the blowhole generation situation is strongly correlated with an X value to be determined according to Formula (1) by the contents of Si, Mn, Ti and Al, which are deoxidizing elements. Especially, according to the findings, generation of a blowhole can be suppressed with certainty when the X value is adjusted in a range of from 1.5 to 3.5%, and conversely when the X value is outside the range of from 1.5 to 3.5%, generation of a blowhole becomes significant.

### Experiment 1

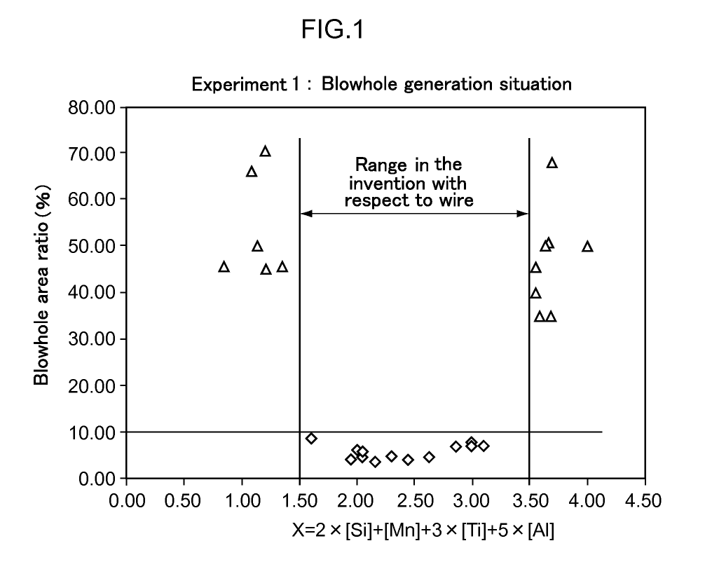

A part of the results of Experiment 1 carried out by the inventors are shown in FIG. 1.

In Experiment 1 ingots of various steel compositions were prepared by melting, then hot-rolled, and a wire was drawn at room temperature. After annealing, the wire was plated with copper, drawn further at room temperature to produce a Φ1.2 mm solid wire. The composition of the solid wire including the plating is in the range of C: from 0.01 to 0.2%, Si: from 0.08 to 0.8%, Mn: from 0.2 to 1.5%, P: 0.02% or less, S: 0.02% or less, Cu: from 0.03 to 0.8%, Al: from 0.05 to 0.4%, and Ti: from 0.001 to 0.3%, wherein the balance is substantially Fe.

Zinc- or zinc alloy-coated steel sheets were welded by lap fillet welding according to the method described in Example below by a gas shielded arc welding method using each solid wire, and carbon dioxide as a shielding gas, and after solidification of a weld metal a blowhole generation situation was investigated. The blowhole generation situation was rated by a blowhole area ratio according to the method described in Example below.

The used zinc- or zinc alloy-coated steel sheet is constituted with a base metal steel sheet plated with zinc on both the sides, which contains the following essential components in a composition of C: from 0.01 to 0.5%, Si: from 0.01 to 2.0%, Mn: from 0.2 to 4.0%, and P: from 0.001 to 0.04%. The thickness of the base metal steel sheet is 2.3 mm, and the coating weight of the zinc plating is 45 g/m² per each side.

In FIG. 1, the results of Experiment 1 are plotted, where the ordinate is for the blowhole area ratio, and the abscissa is for the value of X=2×[Si]+[Mn]+3×[Ti]+5×[Al] with respect to each solid wire.

As is obvious from FIG. 1, it has been found that when the X value is in a range of from 1.5 to 3.5%, the blowhole area ratio is suppressed at an extremely low level of 10% or less. In this regard, when the blowhole area ratio is 10% or less, decrease in the strength of a weld metal is almost not recognizable. Further, when the X value in the above range, the area ratio of slag remaining on a weld metal is as low as 10% or less, and it has been confirmed that the slag does not inhibit electrodeposition coating, and substantially no coating defect is generated therefrom. On the other hand, as shown in FIG. 1, it has become clear that, when the X value is less than 1.5%, the blowhole area ratio jumps up to 40% or more, or when the same exceeds 3.5%, the blowhole area ratio also jumps up to 35% or more. From these experimental results, it is clear that the range of the X value of from 1.5 to 3.5% has sufficient critical value significance for blowhole generation.

Although a factor for each content of an element in Formula (1) determining an X value is based on a statistically processed result derived from relationships between contents in a welding solid wire and a blowhole generation area ratio based on a large number of experiments, by referring to an Ellingham diagram indicating standard free energies of formation of various kinds of oxide, it becomes clear that the magnitude of a factor in Formula (1) with respect to each element content corresponds to the order of oxidation reactivity.

Further the inventors investigated a relationship between a slag generation situation with respect to a solid wire and the amount of Al contained in a weld metal, and the results are shown as the following Experiment 2.

### Experiment 2

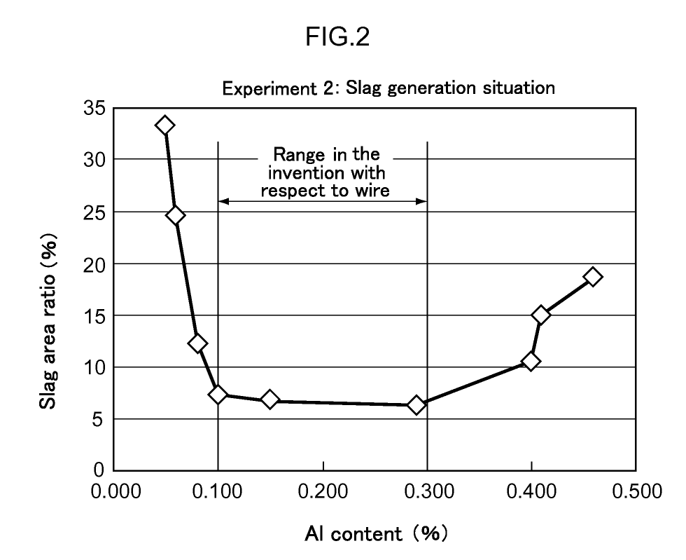

In Experiment 2, zinc-coated steel sheets (sheet thickness: 2.3 mm; coating weight of zinc plating: 45 g/m²) were welded 150 mm long by bead on plate welding, using a Φ0.9 mm solid wire containing by mass % C: 0.05%, Si: 0.8%, Mn: 1.58%, P: 0.005%, S: 0.02%, and Ti: 0.16%, as well as various amounts of Al, and using an Ar+20% CO₂ gas as a shielding gas. Then, a slag area ratio was calculated according to the following formula (3) by the same method as the slag area ratio measuring method described in Example 1 below. As shown in FIG. 2, a relationship between an Al content in a solid wire and a slag area ratio is plotted on the graph.

As is obvious from FIG. 2, it has been found that when the Al content in a solid wire is in a range of from 0.1 to 0.3%, the slag ratio is suppressed at an extremely low level of 10% or less. In this regard, when the slag area ratio is 10% or less, even if electrodeposition coating was applied to a surface of a weld metal having used a solid wire, substantially no coating defect is generated. On the other hand, as shown in FIG. 2, it has become clear that, when the Al content is less than 0.1%, the slag area ratio jumps up to 20% or more, or when the Al content exceeds 0.3%, the slag area ratio also jumps up to 20% or more. From these experimental results, it is clear that the range of the Al content for a solid wire of from 0.1 to 0.3% has sufficient critical value significance for a slag area ratio, namely a slag generation situation.

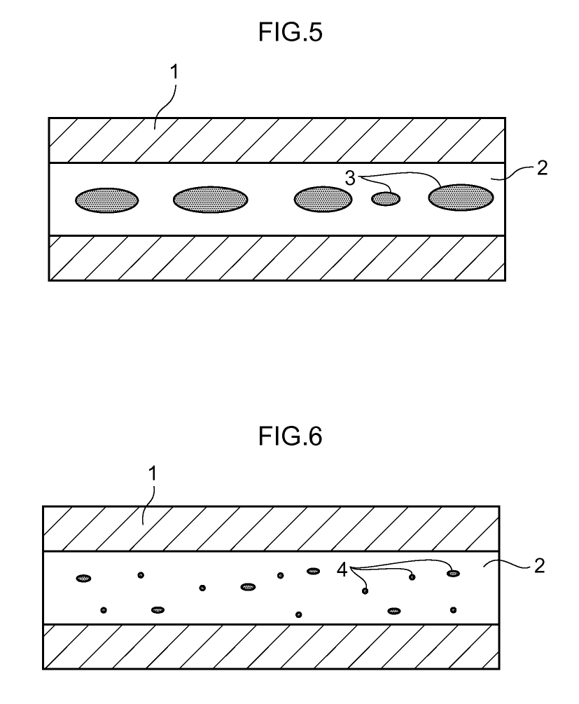

Focusing on slag on a weld bead of a solid wire with an Al content of more or less 0.1 mass %, in the case in which a solid wire with an Al content of 0.05 mass % is used, with respect to slag on a weld bead, as shown in FIG. 5, each piece of slag is large, and the slag area ratio is large. In a case in which a wire with an Al content of 0.15 mass % is used, with respect to slag on a bead, as shown in FIG. 6, each piece of slag becomes finer, and the slag area ratio is small. As is obvious from the above, when the Al content in a solid wire is increased, the slag area ratio is decreased conspicuously, however detailed mechanism therefor is not yet clear. The inventors presume from the above results, that when the Al content is beyond a certain level, Al should have an effect of micronizing a piece of slag.

In FIG. 5 and FIG. 6, 1 indicates a steel sheet. 2 indicates a weld bead. 3 indicates a large sized piece of slag formed on a weld bead surface when gas shielded arc welding is performed using a conventional weld wire, and 4 indicates a fine sized piece of slag formed on a weld bead surface when gas shielded arc welding is performed using a solid wire according to the present invention.

Meanwhile, a preferable embodiment of a solid wire for gas shielded arc welding in the invention (1st Embodiment) contains the following in terms of mass % with respect to the total mass of the wire including plating: C: from 0.03 to 0.15%, Si: from 0.3 to 0.5%, Mn: from 0.4 to 0.8%, P: less than 0.02%, S: less than 0.02%, Al: from 0.15 to 0.3%, Ti: from 0.05 to 0.2%, Cu: from 0 to 0.5%, Cr: from 0 to 2.5%, Nb: from 0 to 1.0%, and V: from 0 to 1.0%, wherein the balance is Fe and impurities, and the value of X defined by the Formula (1) is in a range of from 1.5 to 3.5 mass %.

Further, another preferable embodiment of a solid wire for gas shielded arc welding in the invention (2nd Embodiment) contains the above elements in terms of mass % with respect to the total mass of the wire including plating: namely, C: from 0.03 to 0.15%, Si: from 0.3 to 0.5%, Mn: from 0.4 to 0.8%, P: less than 0.02%, S: less than 0.02%, Al: from 0.15 to 0.3%, and Ti: from 0.05 to 0.2%, further one, or two or more kinds of Cu: from 0.05 to 0.5%, Cr: from 0.005 to 2.5%, Nb: from 0.005 to 1.0%, or V from 0.005 to 1.0%, wherein the balance is Fe and impurities, and the value of X defined by the Formula (1) is similarly as above in a range of from 1.5 to 3.5 mass %.

[Production Method of Solid Wire]

A raw material (steel base metal) for a solid wire in the invention can be produced by producing an ingot which ingredients are regulated in appropriate ranges; producing a wire rod therefrom by forging, rolling, or the like; and then, if necessary, drawing the wire. The material may be annealed in the middle of, or at the end of the process. An ingot may be produced by a batch process, or a continuous casting process. A solid wire in the invention can be produced by, if necessary, plating Cu on the produced raw material for a solid wire.

Although there is no particular restriction on the type or composition of an object steel sheet to be welded with a solid wire in the invention, especially great effect can be obtained, when the wire is applied to gas shielded arc welding of a zinc- or zinc alloy-coated steel sheet. More precisely, although a blowhole is apt to be generated with a zinc- or zinc alloy-coated steel sheet as described above, when a welding solid wire in the invention is applied to gas shielded arc welding of a zinc- or zinc alloy-coated steel sheet, the generation of a blowhole can be remarkably reduced compared to a case in which a conventional general welding solid wire is applied.

An example, by which the function or effect in the invention with respect to a solid wire for gas shielded arc welding as described above is proved, is presented as Example 1.

### Example 1

A production method of a welding solid wire is as follows. An ingot is produced by a vacuum melting method, and processed by forging, rolling, wire drawing, and annealing to a raw wire, which is plated with copper followed by cold wire drawing to produce a Φ1.2 mm solid wire. The chemical composition (contents with respect to the total mass of the wire including plating) of a produced solid wire is shown in Table 1 for wires No. 1 to No. 28. A chemical composition with a content outside the scope in the invention is underlined in Table 1.

Lap fillet welding was conducted by gas shielded arc welding using each wire with a chemical composition shown for wires No. 1 to 28 in Table 1 and either of a 2.3 mm-thick steel sheet (bare steel sheet without zinc plating) with a chemical composition shown in Table 3 as steel sheets No. 1, or No. 2, and zinc-coated steel sheets obtained by hot-dip galvanizing each of steel sheets No. 1, to No. 12 with the similarly tabled chemical compositions. The welding conditions are shown in Table 4. The combination of a wire No, and a steel sheet No. is shown in the right column in Table 1.

In this case, as two base metal steel sheets to be welded, the same kind of steel sheet was used. Further, in the case of a zinc-coated steel sheet, a sheet hot-dip galvanized on both sides at a plating coating weight of 45 g/m² per single side was used.

With respect to an above arc welding experiment for a bare steel sheet and a zinc-coated steel sheet using each welding solid wire, slag generation situation on a weld metal surface after solidification, spatter generation situation during welding, bead appearance of a weld metal, and a blowhole generation situation in a weld metal after solidification were examined and evaluated respectively as follows. The results are shown in Table 2. Examination methods and evaluation criteria are as follows. Since with respect to the evaluation items other than blowhole generation situation, similar evaluation results were obtained for a bare steel sheet and a zinc-coated steel sheet, concerning evaluation items other than blowhole generation situation, only the evaluation results of a zinc-coated steel sheet are shown in Table 2.

[Examination of Slag Generation Situation]

The slag generation situation was evaluated by a slag area ratio. Namely, the central 50 mm-long part of a 150 mm-long weld bead excluding 50 mm-long end parts was examined by taking a photograph to obtain an image of the bead surface, marking slag areas on the image, determining the total area of the marked areas, and from the same and the total image area calculating a slag area ratio according to the following formula (3).

Slag area ratio=Total slag area÷Total image area×100(%) (3)

For evaluation of the slag generation situation, the reference value of slag area ratio is defined as 10%, and 10% or less was rated as “A” (acceptable level), and beyond 10% was rated as “C” (not-acceptable level). This is because, when the slag area ratio is 10% or less, an electrodeposition coating property after welding is favorable including slag areas.

[Evaluation of Spatter Generation Situation]

A spatter generation situation during welding was evaluated by visual observation, and a level which does not interfere with an ordinary welding operation was rated as “A” (acceptable level), and other levels were rated as “C” (not-acceptable level). Incidentally, “level which does not interfere with an ordinary welding operation” means a level where there is no such a big spatter stuck to a steel sheet surface after welding, as requires a posttreatment such as grinding. As a rule of thumb, a particle size of a spatter which requires a posttreatment is 1 mm or more.

[Evaluation of Bead Appearance]

A bead appearance was evaluated by visual observation, a level which is acceptable as a product was rated as “A” (acceptable level), and a level which is not-acceptable as a product having an irregular bead such as, for example, a humping bead, was rated as “C” (not-acceptable level). Incidentally. “irregular bead” means beads such as a weaving bead, a bead with an uneven width, or a bead with a pit (like a hole) on a surface.

[Evaluation of Blowhole Generation Situation]

A blowhole generation situation was evaluated by a blowhole area ratio by observing the inside of a weld metal after solidification by taking an X-ray transmission image.

Specifically, an X-ray transmission photograph of a weld metal part after solidification was taken, and a value calculated by dividing the total area of blowholes by the total area of the weld metal was defined as a blowhole area ratio, and a blowhole area ratio of 10% or less was rated as “A” (acceptable level), and a ratio beyond 10% was rated as “C” (not-acceptable level). This is because, when the blowhole area ratio exceeds 10%, the tensile strength of a weld metal does not satisfy frequently the reference value.

TABLE 1

| | Welding test No. | Wire chemical composition (mass % with respect to total wire mass incl. plating) | | | | | | | | | | | | X value | Steel sheet |
|---|---|---|---|---|---|---|---|---|---|---|---|---|---|---|---|
| Wire type | (Wire No.) | C | Si | Mn | P | S | Al | Ti | Cu | Cr | Nb | V | Fe | (mass %) | No. |
| Example | 1 | 0.05 | 0.40 | 0.50 | 0.006 | 0.005 | 0.300 | 0.100 | 0.28 | — | — | — | balance | 3.10 | 1 |
| | 2 | 0.15 | 0.50 | 0.80 | 0.012 | 0.008 | 0.150 | 0.150 | — | — | — | — | balance | 3.00 | 1 |
| | 3 | 0.05 | 0.45 | 0.75 | 0.006 | 0.007 | 0.100 | 0.003 | 0.25 | 1.200 | — | — | balance | 2.16 | 1 |
| | 4 | 0.14 | 0.45 | 0.30 | 0.001 | 0.001 | 0.140 | 0.050 | 0.24 | — | 0.500 | — | balance | 2.05 | 1 |
| | 5 | 0.09 | 0.20 | 0.35 | 0.005 | 0.015 | 0.120 | 0.200 | — | 0.020 | — | 0.120 | balance | 1.95 | 1 |
| | 6 | 0.05 | 0.40 | 0.80 | 0.001 | 0.001 | 0.100 | 0.100 | 0.24 | 0.030 | 0.070 | — | balance | 2.40 | 1 |
| | 7 | 0.10 | 0.20 | 0.60 | 0.004 | 0.015 | 0.150 | 0.100 | 0.15 | — | — | 0.110 | balance | 2.05 | 1 |
| | 8 | 0.05 | 0.25 | 0.60 | 0.005 | 0.008 | 0.100 | 0.001 | 0.28 | 0.040 | 0.070 | 0.110 | balance | 1.60 | 1 |
| | 9 | 0.11 | 0.20 | 0.50 | 0.001 | 0.001 | 0.250 | 0.100 | 0.19 | — | — | — | balance | 2.45 | 2 |
| | 10 | 0.10 | 0.40 | 0.80 | 0.006 | 0.008 | 0.220 | 0.100 | 0.19 | — | — | 0.120 | balance | 3.00 | 2 |
| | 11 | 0.08 | 0.20 | 0.80 | 0.007 | 0.009 | 0.260 | 0.120 | — | 0.300 | — | — | balance | 2.86 | 2 |
| | 12 | 0.08 | 0.25 | 0.75 | 0.007 | 0.010 | 0.180 | 0.160 | 0.30 | — | — | 0.110 | balance | 2.63 | 2 |
| | 13 | 0.10 | 0.33 | 0.60 | 0.007 | 0.010 | 0.100 | 0.080 | — | — | 0.005 | 0.130 | balance | 2.00 | 2 |
| Comparative | 14 | 0.05 | 0.22 | 0.30 | 0.009 | 0.012 | 0.080 | 0.001 | 0.25 | | 0.050 | 0.110 | balance | 1.14 | 1 |
| Example | 15 | 0.04 | 0.20 | 0.30 | 0.004 | 0.015 | 0.100 | 0.001 | — | — | 0.070 | 0.120 | balance | 1.20 | 1 |
| | 16 | 0.09 | 0.40 | 1.00 | 0.007 | 0.009 | 0.270 | 0.180 | 0.25 | — | — | — | balance | 3.69 | 1 |
| | 17 | 0.08 | 0.45 | 1.00 | 0.007 | 0.009 | 0.300 | 0.200 | 0.20 | — | — | — | balance | 4.00 | 1 |
| | 18 | 0.01 | 0.20 | 0.30 | 0.001 | 0.017 | 0.100 | 0.005 | — | — | — | — | balance | 1.22 | 1 |
| | 19 | 0.19 | 0.45 | 0.80 | 0.010 | 0.005 | 0.270 | 0.180 | 0.31 | 0.040 | — | 0.110 | balance | 3.59 | 1 |
| | 20 | 0.14 | 0.08 | 0.40 | 0.008 | 0.012 | 0.100 | 0.010 | 0.27 | — | — | 0.140 | balance | 1.09 | 1 |
| | 21 | 0.08 | 0.75 | 0.36 | 0.020 | 0.004 | 0.270 | 0.150 | 0.25 | 0.030 | — | — | balance | 3.66 | 1 |
| | 22 | 0.12 | 0.20 | 0.02 | 0.007 | 0.007 | 0.080 | 0.010 | 0.23 | — | — | — | balance | 0.85 | 2 |
| | 23 | 0.07 | 0.45 | 1.00 | 0.012 | 0.008 | 0.270 | 0.130 | 0.30 | — | — | — | balance | 3.64 | 2 |
| | 24 | 0.09 | 0.45 | 0.80 | 0.012 | 0.012 | 0.280 | 0.150 | 0.61 | 0.140 | 0.070 | 0.200 | balance | 3.55 | 2 |
| | 25 | 0.05 | 0.40 | 0.50 | 0.006 | 0.005 | 0.005 | 1.009 | — | — | — | — | balance | 1.35 | 2 |
| | 26 | 0.10 | 0.50 | 0.75 | 0.008 | 0.018 | 0.330 | 0.100 | 0.26 | — | — | — | balance | 3.70 | 2 |
| | 27 | 0.05 | 0.40 | 0.75 | 0.011 | 0.003 | 0.250 | 0.250 | 0.27 | — | — | 0.010 | balance | 3.55 | 2 |
| | 28 | 0.10 | 0.49 | 1.47 | — | — | 0.140 | 0.150 | — | — | — | — | balance | 3.60 | 2 |

X = 2 × [Si] + [Mn] + 3 × [Ti] + 5 × [Al]

TABLE 2

| | | Test results | | | | | | | | |
|---|---|---|---|---|---|---|---|---|---|---|
| | | Slag generation | | | | Bare steel sheet | | Zinc plated | | |
| | Welding | situation | | | | Blowhole | | Blowhole generation | | |
| | test No. | Area | | Spatter | Bead | generation situation | | situation | | |
| | (Wire | ratio | | generation | appear- | Generation | | Generation | | |
| Wire type | No.) | (%) | Rating | situation | ance | rate (%) | Rating | rate (%) | Rating | Remarks |
| Example | 1 | 4.9 | A | A | A | 3.5 | A | 7.00 | A | |
| | 2 | 5.9 | A | A | A | 5.6 | A | 6.90 | A | |
| | 3 | 7.7 | A | A | A | 2.3 | A | 3.60 | A | |
| | 4 | 7.2 | A | A | A | 8.1 | A | 4.50 | A | |
| | 5 | 5.9 | A | A | A | 8.5 | A | 4.00 | A | |
| | 6 | 7.1 | A | A | A | 7.1 | A | 4.60 | A | |
| | 7 | 4.5 | A | A | A | 4.2 | A | 5.60 | A | |
| | 8 | 3.9 | A | A | A | 3.1 | A | 8.50 | A | |
| | 9 | 5.8 | A | A | A | 5.2 | A | 4.00 | A | |
| | 10 | 0.9 | A | A | A | 5.5 | A | 7.70 | A | |
| | 11 | 5.5 | A | A | A | 4.5 | A | 6.90 | A | |
| | 12 | 4.5 | A | A | A | 3.9 | A | 4.50 | A | |
| | 13 | 6 | A | A | A | 7 | A | 6.00 | A | |
| Comparative | 14 | 6.9 | A | C | C | 43 | C | 50.00 | C | Blowholes generated by CO₂ due to |
| Example | | | | | | | | | | insufficient deoxidizing element |
| | 15 | 7.8 | A | C | C | 65 | C | 70.30 | C | Blowholes generated by CO₂ due to |
| | | | | | | | | | | insufficient deoxidizing element |
| | 16 | 8 | A | C | C | 55 | C | 35.00 | C | Blowholes generated by high |
| | | | | | | | | | | viscosity due to excessive |
| | | | | | | | | | | deoxidizing element |
| | 17 | 8.5 | A | C | C | 48 | C | 50.00 | C | Blowholes generated by high |
| | | | | | | | | | | viscosity due to excessive |
| | | | | | | | | | | deoxidizing element |
| | 18 | 7.7 | A | C | C | 7.8 | A | 45.00 | C | Frequent spattering, irregular bead |
| | 19 | 8.5 | A | C | C | 15.0 | C | 35.00 | C | Frequent spattering, irregular bead |
| | 20 | 24.4 | C | A | A | 50.3 | C | 66.10 | C | Large generation amounts of slag |
| | | | | | | | | | | and blowholes |
| | 21 | 12.3 | C | A | A | 75.5 | C | 50.60 | C | Large generation amount of slag |
| | 22 | 7.5 | A | A | A | 77.2 | C | 45.60 | C | Many blowholes |
| | 23 | 8.5 | A | C | C | 7.5 | A | 50.00 | C | Frequent spattering, humping bead |
| | 24 | 6.5 | A | A | C | 5.5 | A | 45.50 | C | Weld metal cracking |
| | 25 | 18.5 | C | A | A | 8.6 | A | 45.50 | C | Large generation amount of slag |
| | 26 | 21.0 | C | A | A | 4.9 | A | 68.00 | C | Large generation amount of slag |
| | 27 | 6.9 | A | C | C | 18.8 | C | 40.00 | C | Frequent spattering, large generation |
| | | | | | | | | | | of blowholes, and bead discontinuity |
| | 28 | — | — | — | — | — | — | 17.0 | C | Generation of blowholes |

TABLE 3

| Steel sheet | Steel chemical composition (mass %) | | | | | | |
|---|---|---|---|---|---|---|---|
| No. | C | Si | Mn | P | S | Ti | Al |
| 1 | 0.16 | 0.01 | 0.89 | 0.007 | 0.003 | — | — |
| 2 | 0.04 | 0.22 | 1.35 | 0.007 | 0.002 | 0.001 | 0.013 |
| 3 | 0.07 | 0.50 | 1.27 | 0.007 | 0.001 | 0.120 | 0.020 |
| 4 | 0.10 | 0.09 | 1.04 | 0.023 | 0.003 | 0.002 | — |
| 5 | 0.14 | 0.09 | 0.69 | 0.017 | 0.009 | — | 0.037 |
| 6 | 0.10 | 0.90 | 0.80 | 0.010 | 0.005 | 0.200 | 0.450 |
| 7 | 0.09 | 0.70 | 1.20 | 0.007 | 0.005 | 0.100 | 0.300 |
| 8 | 0.07 | 0.05 | 0.35 | 0.007 | 0.005 | 0.001 | 0.350 |
| 9 | 0.15 | 0.50 | 0.50 | 0.007 | 0.004 | 0.200 | 0.300 |
| 10 | 0.05 | 0.05 | 0.50 | 0.009 | 0.005 | — | — |
| 11 | 0.24 | 0.60 | 1.50 | 0.010 | 0.007 | 0.160 | 0.270 |
| 12 | 0.12 | 0.55 | 1.40 | 0.008 | 0.007 | 0.020 | 0.400 |

TABLE 4

| | | | | | | Shielding | |
|---|---|---|---|---|---|---|---|
| | Welding | Welding | Welding | Wire | | gas flow | Welding |
| Welding | current | voltage | speed | extension | Shielding | rate | power |
| position | (A) | (V) | (cm/min) | (mm) | gas | (L/min) | source |
| Lap fillet | 145 | 22 | 80 | 15 | Ar + 20% CO₂ | 20 | Pulse |
| welding | | | | | | | MAG |

[Evaluation Results]

In any of examples in the invention No. 1 to No. 13, not only the contents of the respective components of a welding solid wire are in the ranges provided by the invention, but also the X value according to Formula (1) is in a range of from 1.5 to 3.5 provided for a welding solid wire in the invention. In any of the examples in the invention, it has been confirmed that, regardless of whether a bare steel sheet is welded, or a zinc-coated steel sheet is welded, the blowhole area ratio is with certainty below 10%, and generation of a blowhole is suppressed sufficiently. Further, in any of examples in the invention No. 1 to No. 13, the slag area ratio is greatly below 10%, and it has become clear that slag generation is suppressed with certainty. Moreover, it has been confirmed that spatter generation is limited, and bead appearance is favorable.

On the other hand. No. 14 to No. 28 are Comparative Examples, in which any one of the respective components of a welding solid wire is outside the ranges provided by the invention, or the X value according to Formula (1) is outside a range of from 1.5 to 3.5. In the Comparative Examples, especially in the case of a zinc-coated steel sheet, generation of a blowhole became significant, and as noted in the column of Remarks in Table 2, one or more items of slag generation situation, spatter generation situation, and bead appearance were at a not-acceptable level and a favorable bead was not obtained. The respective Comparative Examples will be described in more detail below.

In Comparative Example No. 14, and No. 15, the individual contents of the components of a welding solid wire were within the ranges in the invention, however the X value according to Formula (1) was less than 1.5%. Therefore, in either case of a bare steel sheet, and a zinc-coated steel sheet, blowholes were generated remarkably, spatter generation situation was unfavorable, and bead appearance was poor.

In Comparative Example No. 16, and No. 17, the individual contents of the components of a welding solid wire were within the ranges in the invention, however the X value according to Formula (1) was higher than 3.5%. Therefore, the viscosity of a weld metal in a molten state was excessively high, and in either case of a bare steel sheet, and a zinc-coated steel sheet, blowholes were generated remarkably, spatter generation situation was unfavorable, and bead appearance was poor.

Comparative Example No. 18 is an example, in which the content of C as a component of a welding solid wire was too low, and the X value according to Formula (1) was lower than 1.5%. In this example, since the content of C, which is a generation source of CO₂, was low and the X value was close to the lower limit in the invention of 1.5%, generation of a blowhole could be suppressed in the case of a bare steel sheet, but in the case of a zinc-coated steel sheet, blowholes were generated remarkably due to zinc in a plating layer. Also in this example, spatter occurred frequently and the bead appearance was irregular and poor.

Comparative Example No. 19 is an example, in which the content of C of a welding solid wire was too high, and the X value according to Formula (1) was higher than 4.0%. In this example, a blowhole could be suppressed in the case of a bare steel sheet, but in the case of a zinc-coated steel sheet, blowholes were generated remarkably. Also in this example, spatter occurred frequently and a generation situation was poor, and the bead appearance was also irregular and poor.

Comparative Example No. 20 is an example, in which the content of Si of a welding solid wire was too low, and the X value according to Formula (1) was lower than 1.5%. In this example, a lot of slag was generated, and blowholes were generated remarkably in both the cases of a bare steel sheet, and a zinc-coated steel sheet.

Comparative Example No. 21 is an example, in which the content of Si of a welding solid wire was too high, and the X value according to Formula (1) was higher than 3.5%. In this example, a lot of slag was generated, and blowholes were generated remarkably in both the cases of a bare steel sheet, and a zinc-coated steel sheet.

Comparative Example No. 22 is an example, in which the content of Mn of a welding solid wire was too low, and the X value according to Formula (1) was lower than 1.5%. In this example, blowholes were generated remarkably in both the cases of a bare steel sheet, and a zinc-coated steel sheet.

Comparative Example No. 23 is an example, in which the content of Mn of a welding solid wire was too high, and the X value according to Formula (1) was higher than 3.5%. In this example, a blowhole could be suppressed in the case of a bare steel sheet, but in the case of a zinc-coated steel sheet, blowholes were generated remarkably, further, spatter occurred frequently, and a humping bead was generated to make the bead appearance poor.

Comparative Example No. 24 is an example, in which the content of Cu of a welding solid wire was too high, and the X value according to Formula (1) was higher than 3.5%. In this example, blowholes were generated remarkably in both the cases of a bare steel sheet, and a zinc-coated steel sheet, and weld metal cracking occurred at a bead.

Comparative Example No. 25 is an example, in which the content of Al of a welding solid wire was too low, and the X value according to Formula (1) was lower than 1.5%. In this example, a blowhole could be suppressed in the case of a bare steel sheet, but in the case of a zinc-coated steel sheet, blowholes were generated remarkably, and further a lot of slag was generated.

Comparative Example No. 26 is an example, in which the content of Al of a welding solid wire was too high, and the X value according to Formula (1) was higher than 3.5%. In this example, a blowhole could be suppressed in the case of a bare steel sheet, but in the case of a zinc-coated steel sheet, blowholes were generated remarkably, and further a lot of slag was generated.

Comparative Example No. 27 is an example, in which the content of Ti of a welding solid wire was too high, and the X value according to Formula (1) was higher than 3.5%. In this example, blowholes were generated in both the cases of a bare steel sheet and a zinc-coated steel sheet, and especially in the case of a zinc-coated steel sheet, blowhole generation was conspicuous, spatter furthermore occurred frequently, and a bead became discontinuous.

Comparative Example No. 28 is an example, in which the X value according to Formula (1) was higher than 3.5%. In this example, blowholes were generated in the cases of a zinc-coated steel sheet.

[Weld Metal]

Next, the invention with respect to a weld metal, namely with respect to the 3rd Embodiment and the 4th Embodiment will be described in detail.

A basic embodiment (3rd embodiment) in the invention with respect to a weld metal includes the following in terms of mass % with respect to the total mass of the weld metal: C: from 0.03 to 0.15%, Si: from 0.1 to 0.5%, Mn: from 0.3 to 1.2%, P: 0.02% or less, S: 0.02% or less, Al: from 0.05 to 0.3%, and Ti: from 0.001 to 0.2%; wherein the balance is Fe and impurities, and X expressed by the following formula (2) is in a range of from 1.0 to 4.0 mass %:

X=2×[Si]+[Mn]+3×[Ti]+5×[Al] (2)

wherein [Si], [Mn], [Ti], and [Al] each represent the content (mass %) of the respective elements.

Further, in another embodiment (4th Embodiment) in the invention with respect to a welded joint, a weld metal at the joint includes in addition to the above respective components further one, or two or more kinds of the following by mass %:

Cu: from 0 to 0.3%, Cr from 0 to 1.5%, Nb: from 0 to 0.7%, and V: from 0 to 0.7%.

In this regard, in any of the Embodiments, Si, Mn, Al, and Ti among respective component elements should preferably be in ranges of Si: from 0.3 to 0.5%, Mn: from 0.4 to 1.0%, Al: from 0.1 to 0.2%, and Ti: from 0.05 to 0.2% respectively.

The reasons behind such restrictions on the composition of a weld metal will be described below.

[C: 0.03 to 0.15%]

Since C has an effect of stabilizing an arc and reducing the particle size of a droplet, when the C content is less than 0.03% a droplet becomes too coarse, an arc becomes unstable, and the generation amount of spatter increases. On the other hand, when the C content exceeds 0.15%, the viscosity of a molten metal decreases excessively to deteriorate the bead shape and also to harden a weld metal leading to poor crack resistance. Therefore, the C content in a weld metal is set in a range of from 0.03 to 0.15%.

[Si: 0.1 to 0.5%, Preferably 0.3 to 0.5%]

Si is an element promoting deoxidation of a molten metal during arc welding (deoxidizing element), and has an effect of suppressing generation of a blowhole, on the other hand, however, when Si is contained excessively, this element increases generation of slag significantly. When the Si content is less than 0.1%, deoxidation becomes insufficient, and a blowhole is apt to be generated, and when the Si content exceeds 0.5%, the slag amount increases conspicuously. Consequently for the balance between suppression of blowhole generation and slag amount suppression, the Si content in a weld metal is set in a range of from 0.1 to 0.5%. Furthermore, even within this range, particularly if the Si content is set within a range of from 0.3 to 0.5%, it is possible to achieve both reduction of blowholes and slag amount suppression more effectively.

[Mn: 0.3 to 1.2%, Preferably 0.4 to 1.0%]

Mn is also a deoxidizing element, and has an effect of promoting deoxidation of a molten metal during arc welding and suppressing generation of a blowhole, on the other hand, however, Mn is an element which increases the viscosity of a molten metal. When the Mn content is less than 0.3%, deoxidation becomes insufficient, and a blowhole is apt to be generated. On the other hand, when the Mn content exceeds 1.0%, the viscosity of a molten metal increases, and if the welding speed is high, a molten metal is not able to flow into a weld site appropriately to form a humping bead, and a defective bead shape is apt to appear. Consequently, the Mn content in a weld metal is set in a range of from 0.3 to 1.2%. For reducing the blowhole amount with certainty, the Mn content is more preferably within a range of from 0.4 to 1.0%.

[Al: 0.05 to 0.3%, Preferably 0.1 to 0.2%]

Al is a strongly deoxidizing element and has a strong effect of promoting deoxidation of a molten metal during arc welding, on the other hand, however, it is also an element that promotes generation of slag remarkably. When the Al content is less than 0.05%, deoxidation becomes insufficient, and a blowhole is apt to be generated. When the Al content exceeds 0.3%, slag increases conspicuously. Consequently, for the balance between reduction of blowholes and slag amount suppression, the Al content in a weld metal is set in a range of from 0.05 to 0.3%. Furthermore, even within this range, particularly if the Al content is set within a range of from 0.1 to 0.2%, it is possible to achieve both reduction of blowholes and slag amount suppression more effectively.

[Ti: 0.001 to 0.2%, Preferably 0.05 to 0.2%]

Since Ti is a deoxidizing element, it is an element effective in suppressing generation of a blowhole. When the Ti content is less than 0.001%, this effect cannot be manifested fully. On the other hand, when the Ti content exceeds 0.2%, a slag generation reaction is promoted to increase the slag amount. Consequently, the Ti content in a weld metal is set in a range of from 0.001 to 0.2%. Furthermore, even within this range, particularly if the Ti content set within a range of from 0.05 to 0.2%, the aforedescribed effect can be manifested fully, without invoking increase in the slag amount.

[P: Less than 0.02%]

Since P is an element, which generally comes to be mixed in a steel as an impurity, and is also usually contained as an impurity in a solid wire for arc welding, P is also contained in a weld metal. Meanwhile, since P is one of the major elements, which cause hot crack of a weld metal, P should be preferably suppressed as much as possible. When the P content exceeds 0.02%, hot crack of a weld metal becomes significant, and therefore the P content in a weld metal is limited to 0.02% or less. Although there is no particular restriction on the lower limit of the P content, it is preferably 0.001% from a viewpoint of the cost of dephosphorization and productivity.

[S: Less than 0.02%]

Since S is also an element, which generally comes to be mixed in a steel as an impurity, and is also usually contained as an impurity in a solid wire for arc welding. S is also contained in a weld metal. Meanwhile, since S is an element, which retards the crack resistance of a weld metal. S should be preferably suppressed as much as possible. When the S content exceeds 0.02%, the crack resistance of the weld metal is deteriorated, and therefore the S content in a weld metal is limited to 0.02% or less. Although there is no particular restriction on the lower limit of the S content, it is preferably 0.001% from a viewpoint of the cost of desulfurization and productivity.

[One, or Two or More Kinds of Cu: 0 to 0.3%, Cr: 0.003 to 1.5%, Nb: 0.003 to 0.7%, or V: 0.003 to 0.7%]

Cu is an element, which may be contained in a steel as an impurity. Cr, Nb, and V are elements for improving the strength of a weld metal. In the invention, if necessary, a weld metal contains elements of Cu, Cr, Nb, or V. It may contain only 1 kind of Cu, Cr, Nb, or V or may contain 2 or 3 kinds thereof at the same time.

the Cu content is preferably set in a range of from 0 to 0.3%. Although Cu is an element, that is occasionally contained in a steel generally at approx. 0.02% as an impurity, when the content of Cu in a weld metal exceeds 0.3%, its sensitivity to weld crack grows worse, and therefore the content of Cu in a weld metal is limited to from 0 to 0.3%.

The Cr content is preferably set in a range of from 0 to 1.5%. When Cr is contained, the Cr content is more preferably set in a range of from 0.003% to 1.5%. This is because at the Cr content of 0.003% or more, a strength improvement effect on a weld metal manifests itself however, when the Cr content exceeds 1.5%, the toughness of a weld metal is impaired. The Cr content is preferably 0.3% or more, and more preferably 0.8% or more, from a viewpoint of strength improvement effect.

The Nb content is preferably set in a range of from 0 to 0.7%. When Nb is contained, the Nb content in a weld metal is more preferably set in a range of from 0.003% to 0.7%. This is because at the Nb content of 0.003% or more, a strength improvement effect on a weld metal manifests itself, however, when the Nb content exceeds 0.7%, the toughness of a weld metal is impaired.

The V content is preferably set in a range of from 0 to 0.7%. When V is contained, the V content is more preferably set in a range of from 0.003% to 0.7%. This is because at the V content of 0.003% or more, a strength improvement effect on a weld metal manifests itself however, when the content exceeds 0.7%, the toughness of a weld metal is impaired.

[Impurities]

Impurities means an ingredient contained in a source material, or an ingredient having been mixed in a production process, which is not intentionally added in a weld metal.

Further, with respect to the invention concerning a weld metal, it is important that not only are the individual contents of respective component elements of a weld metal regulated, but also that the relationship among the contents of Si, Mn, Ti, and Al is adjusted, so that under the mutual relationship of the contents, the X value according to Formula (2) should fall within a range of from 1.0 to 4.0%.

Precisely, the inventors have found that even when the individual contents of elements contained in a weld metal are within the above ranges, a large number of blowholes can occasionally exist in a weld metal after solidification. As the result of additional detailed experiments, and investigations, the generation amount of blowholes is strongly correlated with an X value to be determined according to Formula (2) by the contents of Si, Mn, Ti, and Al, which are deoxidizing elements as demonstrated in the following Experiment 3. Especially, the inventors have finally found that by adjusting the amounts of the respective elements so that the X value with respect to a weld metal falls within a range of from 1.0 to 4.0%, blowholes can be reduced with certainty, and, conversely, when the X value is outside the range of from 1.0 to 4.0%, blowholes will increase conspicuously.

### Experiment 3

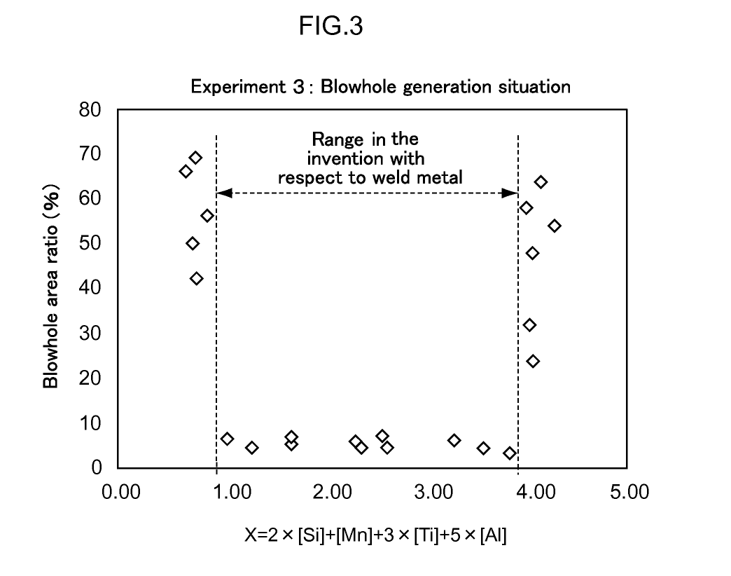

A part of the results of Experiment 3 conducted by the inventors with respect to the invention concerning a weld metal are shown in FIG. 3 similarly as the results of Experiment 1 concerning a welding solid wire (FIG. 1).

In Experiment 3, zinc-coated steel sheets were welded by lap fillet welding by a gas shielded arc welding method using a similar welding solid wire as in Experiment 1 which results are shown FIG. 1 as well as carbon dioxide as a shielding gas according to a method described in Example 2 below, and a blowhole generation situation was examined after solidification of a weld metal. A blowhole generation situation was evaluated by a blowhole area ratio according to the method described in Example 1 above.

A zinc-coated steel sheet identical with Experiment 1 was used.

In FIG. 3 the results of Experiment 3 are plotted, where the ordinate is for the blowhole area ratio, and the abscissa is for the value of X=2×[Si]+[Mn]+3×[Ti]+5×[Al] with respect to each weld metal.

As is obvious from FIG. 3 it has been found that when the X value is in a range of from 1.0 to 4.0%, the blowhole area ratio is suppressed at an extremely low level of 10% or less. In this regard, when the blowhole area ratio is 10% or less, decrease in the strength of a joint is almost not recognizable, and even if electrodeposition coating is applied on to a weld metal surface, substantially no coating defect is generated. On the other hand, as shown in FIG. 3, it has become clear that, when the X value is less than 1.0%, the blowhole area ratio jumps up to 40% or more, or when the X value exceeds 4.0%, the blowhole area ratio also jumps up to 20% or more. From these experimental results, it is clear that the range of the X value with respect to a weld metal from 1.0 to 4.0% has sufficient critical value significance for the amount of blowholes remaining in a weld metal.

Since the inventors further investigated a relationship between a slag generation situation at a weld metal and the amount of Al contained in a weld metal, the results are shown as the following Experiment 4.

### Experiment 4

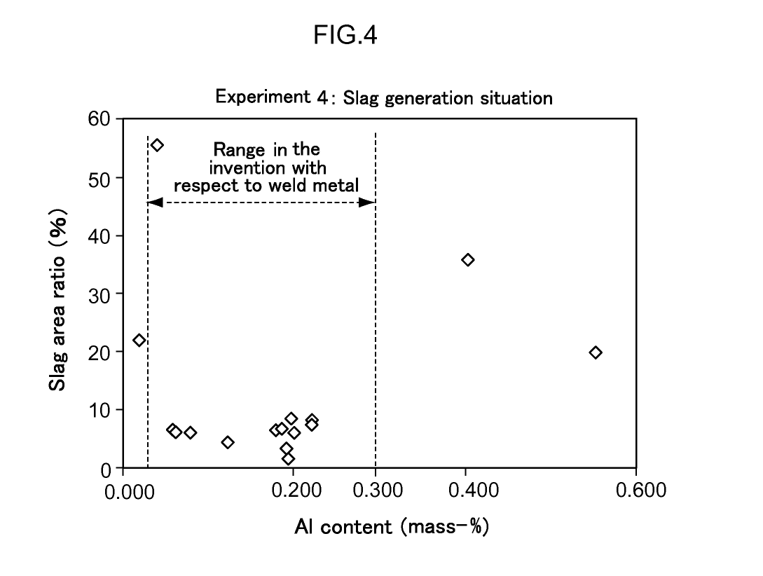

In Experiment 4, zinc-coated steel sheets (sheet thickness: 2.3 mm: coating weight of zinc plating: 45 g/m²) were welded 150 mm long by bead on plate welding using a Φ0.9 mm solid wire containing by mass % C: 0.05%, Si: 0.8%, Mn: 1.58%, P: 0.005%, S: 0.02%, and Ti: 0.16%, as well as various amounts of Al, and using an Ar+20% CO₂ gas as a shielding gas. Then, a slag area ratio was calculated according to the Formula (3) by the same method as the slag area ratio measuring method described in Example 1 above. Then an Al content in a molten metal was examined, and as shown in FIG. 4 a relationship between an Al content in a molten metal and a slag area ratio is plotted on the graph.

As is obvious from FIG. 4, it has been found that when the Al content in a weld metal is in a range of from 0.05 to 0.3%, the slag ratio is suppressed at an extremely low level of 10% or less. In this regard, when the slag area ratio is 10% or less, even if electrodeposition coating is applied to a weld metal surface, substantially no coating defect is generated. On the other hand, as shown in FIG. 4, it has become clear that, when the Al content is less than 0.05%, the slag area ratio jumps up to 20% or more, or when the Al content exceeds 0.3%, the slag area ratio also jumps up to 20% or more. From these experimental results, it is clear that the range of the Al content for a weld metal of from 0.05 to 0.3% has sufficient critical value significance for a slag area ratio, namely a slag generation situation.

It can be known from the experimental results that, when the Al content in a weld metal is in a range of from 0.05 to 0.3%, each piece of slag becomes finer, and the slag area ratio decreases (refer to FIG. 6), and when the Al content in a weld metal is outside the range, each piece of slag becomes larger, and the slag area ratio increases (refer to FIG. 5).

Meanwhile, a preferable embodiment of a weld metal in the invention (3rd Embodiment) contains the following in terms of mass % with respect to the total mass of the weld metal: C: from 0.03 to 0.15%, Si: from 0.3 to 0.5%, Mn: from 0.4 to 1.0%, P: less than 0.02%, S: less than 0.02%, Al: from 0.1 to 0.2%, and Ti: from 0.05 to 0.2%, wherein the balance is Fe and impurities, and the value of X defined by the formula (2) is in a range of from 1.0 to 4.0 mass %.

Further, in another embodiment (4th Embodiment) in the invention with respect to a welded joint, a weld metal at the joint preferably includes in addition to the respective components, namely in addition to C: from 0.03 to 0.15%, Si: from 0.3 to 0.5%, Mn: from 0.4 to 1.0%, P: less than 0.02%, S: less than 0.02%, Al: from 0.1 to 0.2%, and Ti: from 0.05 to 0.2%, further one, or two or more kinds of the following by mass %: Cu: from 0 to 0.3%, Cr: from 0 to 1.5%, Nb: from 0 to 0.7%, and V: from 0 to 0.7%.

Further, in another embodiment (4th Embodiment) in the invention with respect to a welded joint, a weld metal at the joint more preferably includes in addition to the respective components, namely in addition to C: from 0.03 to 0.15%, Si: from 0.3 to 0.5%, Mn: from 0.4 to 1.0%, P: less than 0.02%, S: less than 0.02%, Al: from 0.1 to 0.2%, and Ti: from 0.05 to 0.2%. Further one, or two or more kinds of the following by mass %: Cu: from 0 to 0.3%, Cr: from 0.003 to 1.5%, Nb: from 0.003 to 0.7%, or V: from 0.003 to 0.7%.

Although it is preferable to use a wire according to the 1st or 2nd Embodiment as a welding solid wire for gas shielded arc welding conducted for obtaining the aforedescribed weld metal, the wire is not limited to wires according to the 1st and 2nd Embodiments. More precisely since a component in a weld metal at a welded joint is affected not only by a component in a welding solid wire but also strongly by a component in a base metal, depending on the composition of a base metal, even when a wire other than the wire according to the 1st or 2nd Embodiment is used, it is not impossible to obtain a welded joint with a molten metal satisfying the composition condition and the X value condition (X=from 1.0 to 4.0), provided by the 3rd or 4th Embodiment. Namely, it is only necessary that with respect to a welded joint, the composition of a weld metal after welding satisfies the conditions provided by the 3rd or 4th Embodiment, without being restricted by the composition of a welding solid wire, and therefore various wires can be used according to the composition of a base metal.

An example, by which the function or effect in the invention with respect to a welded joint as described above is proved, is presented as Example 2.

### Example 2

Lap fillet welding was conducted by gas shielded arc welding using as a welding solid wire the same wire as used in Example 1 above, namely a wire with a composition shown in Table 1 (wires No. 1 to No. 27) for a 2.3 mm-thick zinc-coated steel sheet with a chemical composition shown in Table 3 concerning steel sheets No. 1 to 12 (provided that Table 3 shows a composition of a base steel plate before zinc plating). The welding conditions are similarly to Example 1 as shown in Table 4. A zinc-coated steel sheet used for welding has been hot-dip galvanized on both sides at a plating coating weight of 45 g/m² per single side.

Analysis results of the composition of a weld metal at a welded joint obtained by an arc welding experiment with respect to a zinc-coated steel sheet are shown in Table 5. Further, slag generation situation, spatter generation situation during welding, bead appearance of a welded joint, and blowhole generation situation in a weld metal after solidification were examined and evaluated. The results are shown in Table 6. In this regard, an examination method, and evaluation criteria are the same as those described in connection with Example 1

TABLE 5

| | Welding | | | | | | | | | | | | | | | |
|---|---|---|---|---|---|---|---|---|---|---|---|---|---|---|---|---|
| | test | Wire | Steel sheet | Weld metal chemical composition (mass %) | | | | | | | | | | | | X value |
| Wire type | No. | No. | No. | C | Si | Mn | P | S | Al | Ti | Cu | Cr | Nb | V | Fe | (mass %) |
| Example | 31 | 2 | 6 | 0.12 | 0.50 | 0.70 | 0.006 | 0.001 | 0.250 | 0.120 | — | — | — | — | balance | 3.31 |
| | 32 | 3 | 5 | 0.03 | 0.21 | 0.60 | 0.003 | 0.001 | 0.060 | 0.003 | 0.19 | 0.300 | — | — | balance | 1.33 |
| | 33 | 1 | 2 | 0.05 | 0.39 | 0.70 | 0.003 | 0.001 | 0.100 | 0.120 | 0.28 | — | — | — | balance | 2.34 |
| | 34 | 4 | 8 | 0.08 | 0.20 | 0.30 | 0.006 | 0.001 | 0.200 | 0.003 | 0.26 | — | 0.020 | — | balance | 1.71 |
| | 35 | 9 | 7 | 0.11 | 0.40 | 1.00 | 0.003 | 0.000 | 0.250 | 0.168 | 0.25 | — | — | — | balance | 3.55 |
| | 36 | 7 | 3 | 0.09 | 0.40 | 0.80 | 0.003 | 0.000 | 0.100 | 0.100 | 0.25 | — | — | 0.050 | balance | 2.40 |
| | 37 | 8 | 1 | 0.06 | 0.18 | 0.70 | 0.009 | 0.001 | 0.005 | 0.001 | 0.04 | 0.047 | 0.020 | 0.050 | balance | 1.09 |
| | 38 | 5 | 9 | 0.15 | 0.34 | 0.35 | 0.007 | 0.004 | 0.195 | 0.200 | — | 0.020 | — | 0.100 | balance | 2.60 |
| | 39 | 1 | 7 | 0.07 | 0.45 | 0.70 | 0.007 | 0.004 | 0.300 | 0.100 | 0.03 | — | — | — | balance | 3.40 |
| | 40 | 2 | 2 | 0.10 | 0.45 | 1.20 | 0.008 | 0.004 | 0.070 | 0.070 | 0.20 | — | — | — | balance | 2.66 |
| | 41 | 5 | 8 | 0.12 | 0.10 | 0.35 | 0.008 | 0.004 | 0.180 | 0.090 | 0.24 | 0.020 | — | 0.110 | balance | 1.72 |
| Comparative | 42 | 14 | 10 | 0.05 | 0.12 | 0.4 | 0.009 | 0.012 | 0.020 | 0.001 | 0.24 | — | 0.100 | 0.120 | balance | 0.74 |
| Example | 43 | 17 | 7 | 0.08 | 0.48 | 1.15 | 0.007 | 0.010 | 0.290 | 0.170 | 0.35 | — | — | — | balance | 4.07 |
| | 44 | 18 | 10 | 0.02 | 0.15 | 0.40 | 0.001 | 0.017 | 0.015 | 0.002 | — | — | — | — | balance | 0.78 |
| | 45 | 19 | 11 | 0.22 | 0.48 | 1.20 | 0.008 | 0.005 | 0.270 | 0.170 | 0.30 | 0.050 | — | 0.100 | balance | 4.02 |
| | 46 | 20 | 10 | 0.12 | 0.07 | 0.45 | 0.008 | 0.012 | 0.030 | 0.010 | 0.27 | — | — | 0.140 | balance | 0.77 |
| | 47 | 21 | 7 | 0.08 | 0.73 | 1.00 | 0.020 | 0.004 | 0.290 | 0.130 | 0.25 | 0.030 | — | — | balance | 4.30 |
| | 48 | 22 | 10 | 0.07 | 0.15 | 0.20 | 0.006 | 0.007 | 0.030 | 0.008 | 0.23 | — | — | — | balance | 0.67 |
| | 49 | 23 | 11 | 0.14 | 0.50 | 1.40 | 0.011 | 0.008 | 0.270 | 0.100 | 0.30 | — | — | — | balance | 4.05 |
| | 50 | 25 | 10 | 0.05 | 0.20 | 0.45 | 0.006 | 0.005 | 0.003 | 0.004 | — | — | — | — | balance | 0.88 |
| | 51 | 26 | 12 | 0.11 | 0.50 | 1.20 | 0.012 | 0.018 | 0.370 | 0.012 | 0.26 | — | — | — | balance | 4.09 |
| | 52 | 27 | 9 | 0.10 | 0.45 | 1.00 | 0.008 | 0.003 | 0.290 | 0.270 | 0.25 | — | — | 0.005 | balance | 4.16 |

X = 2 × [Si] + [Mn] + 3 × [Ti] + 5 × [Al]

TABLE 6

| | | | | Test results | | | | | |
|---|---|---|---|---|---|---|---|---|---|
| | | | | | | Spatter | | Zinc plated | |
| | Welding test | Wire | Steel | Slag generation situation | | generation | | Blowhole generation situation | |
| Wire type | No. | No. | sheet No. | Area ratio (%) | Rating | situation | Bead appearance | Generation rate (%) | Rating |
| Example | 31 | 2 | 6 | 8.1 | A | A | A | 6.2 | A |
| | 32 | 3 | 5 | 6.4 | A | A | A | 4.4 | A |
| | 33 | 1 | 2 | 6.8 | A | A | A | 6.0 | A |
| | 34 | 4 | 8 | 6.1 | A | A | A | 5.5 | A |
| | 35 | 9 | 7 | 8.3 | A | A | A | 3.5 | A |
| | 36 | 7 | 3 | 4.5 | A | A | A | 4.5 | A |
| | 37 | 8 | 1 | 6.5 | A | A | A | 6.5 | A |
| | 38 | 5 | 9 | 1.5 | A | A | A | 7.2 | A |
| | 39 | 1 | 7 | 6.3 | A | A | A | 4.6 | A |
| | 40 | 2 | 2 | 7.5 | A | A | A | 4.5 | A |
| | 41 | 5 | 8 | 6.5 | A | A | A | 6.9 | A |
| Comparative | 42 | 14 | 10 | 8.8 | A | C | C | 50 | C |
| Example | 43 | 17 | 7 | 41 | C | C | C | 48 | C |
| | 44 | 18 | 10 | 7.9 | A | C | C | 42.0 | C |
| | 45 | 19 | 11 | 9.1 | A | C | C | 58.0 | C |
| | 46 | 20 | 10 | 26.4 | C | A | A | 69.0 | C |
| | 47 | 21 | 7 | 13.5 | C | A | A | 54.0 | C |
| | 48 | 22 | 10 | 6.2 | A | A | A | 66.0 | C |
| | 49 | 23 | 11 | 7.3 | A | C | C | 32.0 | C |
| | 50 | 25 | 10 | 13.4 | C | A | A | 56.0 | C |
| | 51 | 26 | 12 | 12.3 | C | A | A | 24.0 | C |
| | 52 | 27 | 9 | 6.8 | A | C | C | 64.0 | C |

[Evaluation Results]

In any of examples in the invention No. 31 to No. 41, not only the contents of the respective components of a weld metal of a welded joint are in the ranges provided for a welded joint in the invention, but also the X value according to Formula (2) is in a range of from 1.0 to 4.0 provided for a welded joint in the invention, and it has been confirmed with respect to these examples in the invention that the blowhole area ratio is with certainty below 10%, and blowholes are suppressed sufficiently. Further, in any of examples in the invention No. 31 to No. 41, it has become clear that the slag area ratio is below 10%, and slag generation is suppressed with certainty, and further that spatter generation is limited, and bead appearance is favorable.

On the other hand, No. 42 to No. 52 are Comparative Examples, in which any one of the respective components of a weld metal of a welded joint is outside the ranges provided by the invention, or the X value according to Formula (2) is outside a range of from 1.0 to 4.0. In the Comparative Examples, generation of a blowhole became significant, and one or more items of slag generation situation, spatter generation situation, and bead appearance were at a not-acceptable level, and a high quality bead free from various welding defects was not obtained. The respective Comparative Examples will be described in detail below.

In Comparative Example No. 42, the individual contents of the components of a weld metal of a welded joint were within the ranges in the invention, however the X value according to Formula (2) was less than 1.0%. Therefore, blowholes were generated remarkably, spatter generation situation was unfavorable, and bead appearance was poor.

In Comparative Example No. 43, the individual contents of the components of a weld metal of a welded joint were within the ranges in the invention, however the X value according to Formula (2) was higher than 4.0%. As the result, the viscosity of a weld metal in a molten state was excessively high, and blowholes were generated remarkably, the generation amount of slag is large, moreover spatter generation situation was unfavorable, and bead appearance was poor.

Comparative Example No. 44 is an example, in which the C content in a weld metal of a welded joint is too low, and the X value according to Formula (2) is lower than 1.0%. In this example, blowholes were generated remarkably, spatter generation situation was unfavorable, and bead appearance was poor.

Comparative Example No. 45 is an example, in which the C content in a weld metal of a welded joint is too high, and the X value according to Formula (2) is higher than 4.0%. In this example, blowholes were generated remarkably, spatter occurs frequently, and bead appearance was poor.

Comparative Example No. 46 is an example, in which the Si content in a weld metal of a welded joint is too low, and the X value according to Formula (2) is lower than 1.0%. In this example, a large amount of slag was generated, and blowholes were generated remarkably.

Comparative Example No. 47 is an example, in which the Si content in a weld metal of a welded joint is too high, and the X value according to Formula (2) is higher than 4.0%. In this example, a large amount of slag was generated, and blowholes were generated remarkably.

Comparative Example No. 48 is an example, in which the Mn content in a weld metal of a welded joint is too low, and the X value according to Formula (2) is lower than 1.0%. In this example, blowhole generation was conspicuous.

Comparative Example No. 49 is an example, in which the Mn content in a weld metal of a welded joint is too high, and the X value according to Formula (2) is higher than 4.0%. In this example, blowholes were generated remarkably, spatter occurs frequently and spatter generation situation is unfavorable, and further a humping bead was generated to make the bead appearance poor.

Comparative Example No. 50 is an example, in which the Al content in a weld metal of a welded joint is too low, and the X value according to Formula (2) is lower than 1.0%. In this example, blowholes were generated remarkably, and a large amount of slag was generated.

Comparative Example No. 51 is an example, in which the Al content in a weld metal of a welded joint is too high, and the X value according to Formula (2) is higher than 4.0%. In this example, blowholes were generated remarkably, and a large amount of slag was generated.

Comparative Example No. 52 is an example, in which the Ti content in a weld metal of a welded joint is too high, and the X value according to Formula (2) is higher than 4.0%. In this example, blowholes were generated remarkably, spatter occurs frequently, and a bead became discontinuous.

[Welded Joint]

Next, the invention with respect to a welded joint, namely the 5th Embodiment and the 6th Embodiment will be described in detail.

A basic embodiment (5th Embodiment) in the invention with respect to a welded joint is a welded joint including a weld metal at a joint and two base metals, which sandwich the weld metal, and at least one of which is a zinc- or zinc alloy-coated steel sheet (zinc-coated steel sheet or zinc alloy-coated steel sheet), wherein the weld metal is formed by gas shielded arc welding, and is a weld metal according to the 3rd Embodiment or the 4th Embodiment.

In another Embodiment in the invention with respect to a welded joint (6th Embodiment), at least one of the zinc- or zinc alloy-coated steel sheets (zinc-coated steel sheets or zinc alloy-coated steel sheets) among constituting base metals contains Al in an amount of from 0.01 to 0.3% in terms of mass % with respect to the total mass of the steel sheet.

As described above in the invention with respect to a welded joint, at least one of two steel members as base metals (welded material) sandwiching a weld metal at a joint is a zinc- or zinc alloy-coated steel sheet.

In this regard, a zinc alloy-coated steel sheet means a steel sheet, which is plated with a publicly known Zn-base alloy containing zinc as a main component together with Al in an amount of from 0.1 to 0.25% as well as other impurity elements, such as Pb, and Sn.

There is no particular restriction on a production method of a zinc- or zinc-alloy coated steel sheet itself, and ordinarily a publicly known method, such as hot-dip galvanization or alloyed hot-dip galvanization, may be applied.

Although there is no particular restriction on the type or composition of a steel sheet (portion of a base steel sheet of a zinc- or zinc alloy-coated steel sheet) before being subjected to zinc plating (including zinc alloy plating), the steel sheet ordinarily may contain, as essential components, C in an amount of from 0.01 to 0.5%, Si in an amount of from 0.01 to 2.0%, Mn in an amount of from 0.2 to 4.0%, and P in an amount of from 0.001 to 0.04%, and a steel sheet which contains, according to need and use, additionally one, or two or more kinds of Cr in an amount of from 0.01 to 1.5%, V in an amount of from 0.05 to 1.0%, Nb in an amount of from 0.05 to 1.0%, or the like, may be used. Further, when a zinc- or zinc alloy-coated steel sheet is used for only one of two steel members as base metals (welded material) sandwiching a weld metal at a joint, there is no particular restriction on the type or composition of the other steel member (ordinarily a plate, but not limited thereto, and may be a pipe, a rod, or the like), and a steel similar to a steel at the portion of a base steel sheet of the zinc- or zinc alloy-coated steel sheet may be used.

In a case in which a zinc- or zinc alloy-coated steel sheet contains Al in an amount of from 0.01 to 0.3% in terms of mass % with respect to the total mass of a steel sheet, when a weld metal is formed with a weld wire according to the 1st Embodiment or the 2nd Embodiment, the X value according to Formula (2) can be easily regulated to a range of from 1.0 to 4.0%, and the Al content can be easily regulated to a range of from 0.05 to 0.3%, so that a blowhole generation amount, and a slag generation amount can be easily suppressed. In other words, even when a zinc- or zinc alloy-coated steel sheet with a reduced Al content is used as one of the base metals, a welded joint which has suppressed a blowhole generation amount, and a slag generation amount in a weld metal at a joint can be easily obtained.

The zinc- or zinc alloy-coated steel sheet may be plated either on both sides, or on a single side. Although there is no particular restriction on the thickness of a plating layer of the zinc- or zinc alloy-coated steel sheet, however when a target is an automobile suspension system, a preferable plating coating weight is desirably approx. from 30 to 120 g/m² per single side.

The thickness of a zinc- or zinc alloy-coated steel sheet constituting at least one of two steel members as base metals (welded material) sandwiching a weld metal at a joint is preferably from 0.5 mm to 4 mm from the viewpoint of practical use as a member of an automobile suspension system using a thin steel sheet.

Further, there is no particular restriction on a specific shape of a welded joint or a specific mode of welding for forming a welded joint (welding position), and for example, lap fillet welding or fillet welding of T-shaped joint may be applied.

### [Weldment]

Next, the invention concerning a weldment, namely the 7th Embodiment will be described in detail.

A basic embodiment (7th Embodiment) in the invention with respect to a weldment is provided with a welded joint according to the 5th Embodiment or the 6th Embodiment.

Referring to the invention with respect to a weldment, as a weldment provided with a welded joint, there are, for example, a structural member for an automobile suspension system, and a structural member for a prefabricated house.

[Welding Method, Production Method of Welded Joint]

Next, the inventions concerning a welding method, and a production method of a welded joint, namely the 8th Embodiment and the 9th Embodiment will be described in detail.

A basic embodiment (8th Embodiment) in the invention with respect to a welding method is a method for welding two base metals, at least one of which is a zinc- or zinc alloy-coated steel sheet (zinc-coated steel sheet or zinc alloy-coated steel sheet), by forming a weld metal at a joint by gas shielded arc welding using a solid wire for gas shielded arc welding according to the 1st Embodiment, or the 2nd Embodiment.

A basic embodiment (9th Embodiment) in the invention with respect to a production method of a welded joint is a method for producing a welded joint constituted with a weld metal at a joint, and two base metals, at least one of which is a zinc- or zinc alloy-coated steel sheet (zinc-coated steel sheet or zinc alloy-coated steel sheet), sandwiching the weld metal, and is a method for forming the weld metal by gas shielded arc welding using a solid wire for gas shielded arc welding according to the 1st Embodiment, or the 2nd Embodiment.

Referring to the inventions concerning a welding method, and a production method of a welded joint, when a zinc- or zinc alloy-coated steel sheet is welded by gas shielded arc welding using a solid wire for gas shielded arc welding according to the 1st Embodiment, or the 2nd Embodiment, generation of blowholes and slag can be remarkably reduced compared to a case where a conventional welding solid wire is used.

In this case, a zinc- or zinc alloy-coated steel sheet to be used is similar to the zinc- or zinc alloy-coated steel sheet described with respect to a welded joint according to the 5th Embodiment, or the 6th Embodiment. Especially when a zinc- or zinc alloy-coated steel sheet containing Al from 0.01 to 0.3% in terms of mass % with respect to the total mass of a steel sheet, a blowhole generation amount, and a slag generation amount can be easily suppressed.

There is no particular restriction on a specific mode of welding (welding position), and for example, the same is applicable to lap fillet welding or fillet welding of T-shaped joint. Also there is no particular restriction on the kind of a shielding gas to be used, and, for example, such a shielding gas as a 100% CO₂ gas, an Ar+20% CO₂ gas, and an Ar+2% O₂ gas may be used. Especially when a 100% CO₂ gas, or an Ar+20% CO₂ gas is used as a shielding gas, a remarkable effect in the invention can be exhibited.

While the present invention has been described by way of the preferred Embodiments and Examples, it will be understood that such Embodiments and Examples are merely for exemplary and explanatory purpose within the scope and spirit of the present invention, and that any addition, omission, substitution, and other modifications of constituents are possible without departing from the scope and spirit of the present invention. Namely, it is intended that the present invention is not limited by the particular descriptions above, but limited only by the scope of the attached claims allowing appropriate modifications within the scope.

The disclosure of Japanese Patent Application No. 2013-027411 is hereby incorporated by reference herein in its entireties.

All the literature, patent literature, and technical standards cited herein are also herein incorporated to the same extent as provided for specifically and severally with respect to an individual literature, patent literature, and technical standard to the effect that the same should be so incorporated by reference.

1. A solid wire for gas shielded arc welding, comprising the following in terms of mass % with respect to a total mass of the wire including plating:
C: from 0.03 to 0.15%,
Si: from 0.2 to 0.5%,
Mn: from 0.3 to 0.8%,
P: 0.02% or less,
S: 0.02% or less,
Al: from 0.1 to 0.3%,
Ti: from 0.001 to 0.2%
Cu: from 0 to 0.5%,
Cr: from 0 to 2.5%,
Nb: from 0 to 1.0%, and
V: from 0 to 1.0%
wherein the balance is Fe and impurities, and a value of X defined by the following formula (1) is in a range of from 1.5 to 3.5 mass %:
X=2×[Si]+[Mn]+3×[Ti]+5×[Al] (1)
wherein [Si], [Mn], [Ti], and [Al] each represent a content (mass %) of the respective elements.

2. The solid wire for gas shielded arc welding according to claim 1, comprising one, or two or more kinds of the following in terms of mass % with respect to the total mass of the wire including plating:
Cu: from 0.05 to 0.5%,
Cr: from 0.005 to 2.5%,
Nb: from 0.005 to 1.0%, or
V: from 0.005 to 1.0%.

3. A weld metal by gas shielded arc welding, comprising the following in terms of mass % with respect to a total mass of the weld metal:
C: from 0.03 to 0.15%,
Si: from 0.1 to 0.5%,
Mn: from 0.3 to 1.2%,
P: 0.02% or less,
S: 0.02% or less,
Al: from 0.05 to 0.3%, and
Ti: from 0.001 to 0.2%
wherein the balance is Fe and impurities, and a value of X defined by the following formula (2) is in a range of from 1.0 to 4.0 mass %:
X=2×[Si]+[Mn]+3×[Ti]+5×[Al] (2)
wherein [Si], [Mn], [Ti], and [Al] each represent a content (mass %) of the respective elements.

4. The weld metal by gas shielded arc welding according to claim 3, further comprising one, or two or more kinds of the following in terms of mass % with respect to the total mass of the weld metal:
Cu: from 0 to 0.3%,
Cr: from 0 to 1.5%,
Nb: from 0 to 0.7%, or
V: from 0 to 0.7%.

5. A welded joint comprising a weld metal formed by gas shielded arc welding at a joint, and two base metals, which sandwich the weld metal, and at least one of which is a zinc-coated steel sheet or a zinc alloy-coated steel sheet, wherein the weld metal is the weld metal by gas shielded arc welding according to claim 3.

6. The welded joint according to claim 5, wherein the zinc-coated steel sheet or the zinc alloy-coated steel sheet comprises Al in a range of from 0.01 to 0.3 mass % with respect to a total mass of the steel sheet.

7. A weldment comprising the welded joint according to claim 5.

8. A welding method for welding two base metals, at least one of which is a zinc-coated steel sheet or a zinc alloy-coated steel sheet, by forming a weld metal at a joint by gas shielded arc welding using the solid wire for gas shielded arc welding according to claim 1.

9. A production method of a welded joint comprising a weld metal at a joint and two base metals, which sandwich the weld metal, and at least one of which is a zinc-coated steel sheet or a zinc alloy-coated steel sheet, wherein the weld metal is formed by gas shielded arc welding using the solid wire for gas shielded arc welding according to claim 1.
